(19) United States
(12) Patent Application Publication
(10) Pub. No.: US 2014/0033561 A1
(43) Pub. Date: Feb. 6, 2014

(54) HOME LAUNDRY DRYER

(71) Applicants: Alberto Bison, Pordenone (PN) (IT); Francesco Cavarretta, Pordenone (PN) (IT)

(72) Inventors: Alberto Bison, Pordenone (PN) (IT); Francesco Cavarretta, Pordenone (PN) (IT)

(73) Assignee: ELECTROLUX HOME PRODUCTS CORPORATION N.V., Brussels (BE)

(21) Appl. No.: 13/997,903

(22) PCT Filed: Dec. 21, 2011
(86) PCT No.: PCT/EP2011/073610

§ 371 Date: Oct. 1, 2013

(30) Foreign Application Priority Data
Dec. 27, 2010 (EP) 10197042.4

(51) Int. Cl. F26B 23/00

(52) U.S. Cl. CPC F26B 23/005
USPC 34/468; 34/75

(57) ABSTRACT

A laundry dryer includes a heat-pump assembly configured to cool airflow coming from a laundry container and then to heat airflow returning to the laundry container. The heat-pump assembly has a first heat exchanger configured to transfer heat from the airflow arriving from the laundry container to a low-pressure refrigerant, and a second heat exchanger configured to transfer heat from a high-pressure refrigerant to the airflow directed back into the laundry container. The heat pump assembly has a refrigerant cooler or refrigerant flow-rate adjuster which are configured to adjust, respectively, the temperature or the pressure of the low-pressure refrigerant, and a detector configured to measure one physical quantity of the laundry dryer. The heat pump assembly also includes an auxiliary heat exchanger which transfers heat from the high-pressure refrigerant to the low-pressure refrigerant.

### BACKGROUND

Embodiments of the present invention relate to a home laundry dryer.

In particular, embodiments of the present invention relate to a rotary-drum, heat-pump type, home laundry dryer, to which the following description refers purely by way of example without implying any loss of generality.

As is known, today's rotary-drum home laundry dryers comprise: a substantially parallelepiped-shaped outer boxlike casing configured to rest on the floor; a substantially cylindrical, hollow revolving drum configured to internally house the laundry to be dried, and which is housed in axially rotating manner inside the casing to rotate about its horizontally-oriented longitudinal axis, directly facing a laundry loading/unloading through opening realized in the front wall of the casing; a door hinged to the front wall of the casing to rotate to and from a closing position in which the door rests completely against the front wall of the casing to close the laundry loading/unloading opening and airtight seal the revolving drum; and an electrically-powered motor assembly configured to drive into rotation the revolving drum about its longitudinal axis inside the casing.

Rotary-drum home laundry dryers of the above type are also provided with a closed-circuit, hot-air generator which is designed to circulate inside the revolving drum a stream of hot air having a low moisture content, and which flows through the revolving drum and over the laundry inside the drum to rapidly dry said laundry; and with an electronic central control unit which controls both the motor assembly and the hot-air generator to perform one of the user-selectable drying cycles stored in the same central control unit.

In the heat-pump type, home laundry dryers, the closed-circuit, hot-air generator comprises an air recirculating conduit having its two ends connected to the revolving drum, on opposite sides of the latter; an electric centrifugal fan located along the air recirculating conduit to produce, inside the latter, an airflow which flows through the revolving drum; and finally a heat-pump assembly having its two heat exchangers located one after the other, along the air recirculating conduit.

More specifically, the heat-pump assembly comprises a first air/refrigerant heat exchanger which provides for rapidly cooling the airflow arriving from the revolving drum to condense and restrain the surplus moisture in the airflow; a second air/refrigerant heat exchanger which provides for rapidly heating the airflow arriving from the first heat exchanger and directed back to the revolving drum, so that the airflow re-entering into the revolving drum is heated rapidly to a temperature higher than or equal to that of the airflow coming out of the drum; and an electrically-powered refrigerant compressing device which is interposed between the refrigerant-outlet of the first air/refrigerant heat exchanger and the refrigerant-inlet of the second air/refrigerant heat exchanger, and it is configured to continuously compress the gaseous-state refrigerant directed towards the second heat exchanger so that refrigerant pressure and temperature are much higher at the refrigerant-inlet of the second heat exchanger than at the refrigerant-outlet of the first heat exchanger.

The first air/refrigerant heat exchanger is traditionally called “evaporator”, and it is configured so that the airflow arriving from the revolving drum and the low-pressure and low-temperature refrigerant directed to the suction of the refrigerant compressing device can flow through it simultaneously, allowing the refrigerant having a temperature lower than that of the airflow, to absorb heat from the airflow, thus causing condensation of the surplus moisture in the airflow arriving from the revolving drum; whereas the second air/refrigerant heat exchanger is traditionally called “condenser”, and it is configured so that the airflow directed back into the revolving drum and the high-pressure and high-temperature refrigerant arriving from the delivery of the refrigerant compressing device can flow through it simultaneously, allowing the refrigerant having a temperature greater than that of the airflow to release heat to the airflow, thus rapidly heating the airflow directed back into the drum.

Finally the heat-pump assembly is provided with a refrigerant expansion device which is interposed between the refrigerant-outlet of the condenser and the refrigerant-inlet of the evaporator, and it is configured so as to cause a rapid expansion of the refrigerant directed towards the evaporator so that refrigerant pressure and temperature are much higher at the refrigerant-outlet of the condenser than at the refrigerant-inlet of the evaporator.

As is known, at present, the use of a heat-pump assembly is the most energy efficient and cost effective way to continually dehumidify the airflow circulating inside the revolving drum.

Notwithstanding the above, there are several technical issues correlated to the interaction between the heat-pump assembly and the airflow circulating inside the air recirculating conduit of the laundry dryer, which causes a slight reduction of the energy efficiency. These issues are mainly due to the typical behavior of every heat-pump system.

First of all the heat-pump assembly has a quite long warm-up time which significantly lengthens the drying cycle. In fact, contrary to traditional closed-circuit hot-air generators where the resistor immediately transfers the heat to the airflow directed back into the revolving drum, in heat-pump type, hot-air generators the heat to be supplied to the airflow directed back into the revolving drum is to be recovered from the upstream dehumidification of the same airflow. However the air dehumidification is very low at beginning of the drying cycle (low moist quantity extracted from the air) and it increases as the drying cycle proceeds, thus it takes a lot of time to the heat-pump assembly to reach the steady-state full-power working condition in which the temperature of the airflow circulating into the revolving drum reaches the highest value and remains substantially constant to said highest value.

A possible solution to the long warm-up time of the heat-pump assembly is the insertion of an auxiliary resistor along the air recirculating conduit to speed up the warm-up time. Obviously the use of this resistor increases the electric energy consumption.

A second problem correlated to the use of a heat-pump type hot-air generators is the intrinsically unbalanced energy balance between the heat absorbed from the airflow in the evaporator, i.e. in the first air/refrigerant heat exchanger, and the heat supplied to the airflow in the condenser, i.e. in the second air/refrigerant heat exchanger, when the hot-air generator is in the steady-state full-power working condition.

In fact, in the steady-state full-power working condition the air flowing along the air recirculating conduit of the hot-air generator should give off and absorb approximately the same quantity of heat to return at the same temperature as when coming out of revolving drum.

These conditions, however, are badly matched by the heat-pump assembly because the air heating power at the condenser is always higher than the air cooling power at the evaporator. The condenser, in fact, must also dissipate the heat produced by the refrigerant compressing device itself.

This results in a continuous increase of the temperature of the air directed towards the drum, and in a continuous increase of the refrigerant pressure and temperature at delivery side of the refrigerant compressing device.

On one side this behavior is useful at the beginning of the drying cycle since it speeds up the warm-up phase, but on the other side it becomes really negative when hot-air generator reaches the steady-state full-power working condition.

In the steady-state working phase, in fact, the air/refrigerant heat exchange in the condenser, i.e. in the second heat exchanger, is limited because the temperature difference between the air and the refrigerant is relatively low. Since the refrigerant circulates in close loop also in the evaporator, i.e. in the first heat exchanger, the reduced air/refrigerant heat exchange capacity leads to a consequent limitation of the air cooling capacity of the refrigerant in the evaporator, where much more energy could be exchanged due to the dehumidification process. The latent condensation heat of the water, i.e. of the moisture, in fact is very high.

Obviously this limitation of the air/refrigerant heat exchange capacity at evaporator, i.e. at first heat exchanger, considerably decreases the dehumidification-process efficiency and penalizes the drying time.

Moreover the increase of refrigerant temperature and pressure at suction and at delivery of the refrigerant compressing device becomes dangerous for the refrigerant compressing device itself, and shorten its working life.

In view of the heat-pump behavior referred above, several solutions have been developed to dissipate the excess of heat at the condenser of the hot-air generator, when the hot-air generator reaches the desired steady-state full-power working condition.

Initially the applicant tried to overcome these drawbacks via cooling down the body of the refrigerant compressing device by means of a cold airflow that an auxiliary electric fan draws from the outside of the laundry dryer. However this solution is not enough energy efficient.

Another applicant solution envisage the use of a third air/refrigerant heat exchanger in series to the second air/refrigerant heat exchanger, i.e. to the condenser, immediately downstream the latter. This third air/refrigerant heat exchanger is cooled by a cold airflow that an auxiliary electric fan draws from the outside of the laundry dryer, so as to slightly cool down the high-temperature and high-pressure refrigerant directed towards the refrigerant expansion device.

This second solution significantly increases the air/refrigerant heat exchange capacity at high-pressure side of heat-pump assembly and, as a consequence, significantly increases the available air cooling capacity of the refrigerant in the first heat exchanger, i.e. in the evaporator.

The main drawback of this second solution is that the air cooling capacity of the refrigerant in the evaporator, i.e. in the first air/refrigerant heat exchanger, is strictly limited by the fact that the refrigerant must be completely vaporized, i.e. completely in gaseous state, at suction of refrigerant compressing device, and the use of the third air/refrigerant heat exchanger may cause the refrigerant to be still partially in liquid state when coming out of the evaporator, i.e. of the first air/refrigerant heat exchanger, directed to the suction of the refrigerant compressing device, with all problems concerned.

More specifically, if the third air/refrigerant heat exchanger cools down too much the refrigerant, the heat absorbed from the airflow arriving from the revolving drum is not enough to completely vaporize the refrigerant flowing along the evaporator. Thus, an excessive cooling of the refrigerant at the high-pressure side of the heat-pump assembly can deteriorate the refrigerant “vapor quality” at suction of the refrigerant compressing device, up to irreparably damage the structural integrity of the refrigerant compressing device.

In other words, a third air/refrigerant heat exchanger that cools down the refrigerant too much, may cause the refrigerant “vapor quality” at suction of the refrigerant compressing device to be below 1. The refrigerant “vapor quality” at suction of the refrigerant compressing device, in fact, is the ratio, determined at suction of the refrigerant compressing device, between the amount of refrigerant in gaseous state and the total amount of refrigerant (i.e. both in liquid and gaseous state). A “vapor quality” equal to 1 means that all refrigerant is in gaseous state (saturated vapor refrigerant or superheated refrigerant), whereas a “vapor quality” equal to 0 means that all refrigerant is in liquid state (saturated liquid refrigerant or sub-cooled refrigerant).

Obviously, it is preferably not to have, at suction of the refrigerant compressing device, a refrigerant with a “vapor quality” lower than 1.

### SUMMARY OF SELECTED INVENTIVE ASPECTS

One aim of embodiments of the present invention is to improve efficiency and performances of the heat-pump type, hot-air generator of today's rotary-drum home laundry dryers, and to eliminate the drawbacks referred above.

In compliance with the above aims, according to embodiments of the present invention there is provided a home laundry dryer as specified in Claim 1 and, in some embodiments, as in any one of the dependant claims.

In compliance with the above aims, according to embodiments of the present invention there is provided a laundry dryer comprising an outer boxlike casing configured to rest on the floor and, inside the casing, a laundry container configured to house the laundry to be dried, and a closed-circuit, hot-air generator configured to circulate through the laundry container a stream of hot air;

the hot-air generator in turn comprising: an air recirculating conduit having its two ends connected to the laundry container; air circulating means configured to produce, inside the air recirculating conduit, an airflow which flows through said laundry container; and a heat-pump assembly configured to cool the airflow coming out from the laundry container for condensing the moisture in said airflow, and then to heat the airflow returning back into the laundry container;

said heat-pump assembly comprising: a first air/refrigerant heat exchanger which is located along the air recirculating conduit, and it is configured to transfer heat from the airflow arriving from the laundry container to the refrigerant so as to condense the moisture in the airflow; a second air/refrigerant heat exchanger which is located along the air recirculating conduit, downstream of the first heat exchanger, and it is configured to transfer heat from the refrigerant to the airflow directed back into the laundry container so as to heat said airflow; a refrigerant compressing device which is interposed between the refrigerant-outlet of the first heat exchanger and the refrigerant-inlet of the second heat exchanger, and it is configured to compress the refrigerant directed towards the second heat exchanger so that refrigerant pressure and temperature are much higher at refrigerant-inlet of the second heat exchanger than at refrigerant-outlet of the first heat exchanger; and a refrigerant expansion device which is interposed between the refrigerant-outlet of the second heat exchanger and the refrigerant-inlet of the first heat exchanger, and it is configured so as to produce an expansion of the refrigerant;

wherein said heat-pump assembly additionally comprises:
an auxiliary refrigerant/refrigerant heat exchanger comprising a high-pressure side and a low-pressure side, and which is configured so that the high- and low-pressure sides are terminally coupled one another so to allow heat transfer from the high-pressure and high-temperature refrigerant to the low-pressure and low-temperature refrigerant;
refrigerant cooling means or refrigerant flow-rate adjusting means which are configured to adjust the temperature or the pressure of the low-pressure refrigerant at refrigerant-outlet of the first heat exchanger; and
detecting means able to measure the current value of at least one physical quantity associated to the heat-pump assembly and/or to the airflow; and
a central control unit configured to control said refrigerant cooling means or refrigerant flow-rate adjusting means according to the time-progression of said at least one physical quantity.
   Furthermore, in some embodiments the central control unit is configured to control said refrigerant cooling means or refrigerant flow-rate adjusting means so as to selectively maintain between 0.7 and 1.2 the value of the “thermodynamic quality ratio” of the refrigerant at refrigerant-outlet of said first heat exchanger; the “thermodynamic quality ratio” of the refrigerant being defined by the equation:

$$TQ = \frac{H - {H}_{sat}^{L}}{{H}_{sat}^{V} - {H}_{sat}^{L}}$$

wherein H is the current Enthalpy of the refrigerant at refrigerant-outlet of the first heat exchanger; Hₛₐₜ^{L} is the Enthalpy of the refrigerant when in Saturated Liquid Condition at current pressure of the refrigerant; and Hₛₐₜ^{V} is the Enthalpy of the refrigerant when in Saturated Vapor Condition at current pressure of the refrigerant.

Furthermore and preferably, though not necessarily, the central control unit is configured to control said refrigerant cooling means or refrigerant flow-rate adjusting means so as to maintain the “thermodynamic quality ratio” of the refrigerant at refrigerant-outlet of the first heat exchanger between 0.7 and 1.15, or between 1 and 1.15.

Furthermore and preferably, though not necessarily, the central control unit is configured to control said refrigerant cooling means or refrigerant flow-rate adjusting means so as to maintain the “thermodynamic quality ratio” of the refrigerant at refrigerant-outlet of the first heat exchanger between 0.7 and 1.07, or between 1 and 1.07.

Furthermore and preferably, though not necessarily, the central control unit is configured to control said refrigerant cooling means or refrigerant flow-rate adjusting means so as to maintain the “thermodynamic quality ratio” of the refrigerant at refrigerant-outlet of the first heat exchanger between 0.7 and 1.03, or between 1 and 1.03.

Furthermore and preferably, though not necessarily, said at least one physical quantity is the temperature and/or pressure of the refrigerant at refrigerant-inlet or at refrigerant-outlet of said first air/refrigerant heat exchanger; and/or the temperature rise or drop of the refrigerant flowing through said first air/refrigerant heat exchanger.

Furthermore and preferably, though not necessarily, said at least one physical quantity is the temperature and/or pressure of the refrigerant at low-pressure refrigerant inlet or at low-pressure refrigerant outlet of the low-pressure side of said refrigerant/refrigerant heat exchanger; and/or the temperature and/or pressure of the refrigerant at high-pressure refrigerant inlet or at high-pressure refrigerant outlet of the high-pressure side of said refrigerant/refrigerant heat exchanger; and/or the temperature rise of the refrigerant flowing through the low-pressure side of said refrigerant/refrigerant heat exchanger; and/or the temperature drop of the refrigerant flowing through the high-pressure side of said refrigerant/refrigerant heat exchanger.

Furthermore and preferably, though not necessarily, said at least one physical quantity is the temperature and/or pressure of the refrigerant at suction and/or at delivery of said refrigerant compressing device.

Furthermore and preferably, though not necessarily, said at least one physical quantity is the temperature and/or pressure of the refrigerant at refrigerant inlet or at refrigerant outlet of said second air/refrigerant heat exchanger.

Furthermore and preferably, though not necessarily, said at least one physical quantity is the temperature and/or moisture degree of the airflow entering into, or coming out of, said laundry container.

Furthermore and preferably, though not necessarily, the refrigerant cooling means comprises a third air/refrigerant heat exchanger which is connected in series to the second air/refrigerant heat exchanger, and it is configured so as to selectively cool down the high-pressure refrigerant directed towards the refrigerant expansion device.

Furthermore and preferably, though not necessarily, said refrigerant cooling means additionally comprises an auxiliary ventilation device which is configured to channel, on command, a stream of cooling air towards the body of said third air/refrigerant heat exchanger.

Furthermore and preferably, though not necessarily, said refrigerant flow-rate adjusting means comprises a variable speed refrigerant compressing device, or an electrically-operated refrigerant expansion valve, or an electrically-operated multiple capillary-tube expansion system.

Furthermore and preferably, though not necessarily, said detecting means comprises sensor means configured to detect the temperature and/or pressure of the refrigerant at low-pressure refrigerant inlet of said refrigerant/refrigerant heat exchanger, and/or at low-pressure refrigerant outlet of said refrigerant/refrigerant heat exchanger, and/or at high-pressure refrigerant inlet of said refrigerant/refrigerant heat exchanger, and/or at high-pressure refrigerant outlet of said refrigerant/refrigerant heat exchanger.

Moreover, according to embodiments of the present invention, there is also provided an operating method of a laundry dryer comprising an outer boxlike casing configured to rest on the floor and, inside the casing, a laundry container configured to house the laundry to be dried, and a closed-circuit, hot-air generator configured to circulate through the laundry container, on command, a stream of hot air; the hot-air generator being provided with a heat-pump assembly configured to cool the airflow coming out from the laundry container for condensing the moisture in said airflow, and then to heat the airflow returning back into the laundry container;

said heat-pump assembly comprising: a first air/refrigerant heat exchanger which is configured to transfer heat from the airflow arriving from the laundry container to a low-pressure refrigerant so as to condense the moisture in the airflow; and a second air/refrigerant heat exchanger which is configured to transfer heat from a high-pressure refrigerant to the airflow directed back into the laundry container so as to heat said airflow;

wherein the operating method comprises the steps of
measuring the current value of at least one physical quantity associated to the heat-pump assembly and/or to the airflow;
controlling, on the basis of the time-progression of said at least one physical quantity, refrigerant cooling means or refrigerant flow-rate adjusting means configured to adjust the temperature or pressure of the low-pressure refrigerant at refrigerant-outlet of the first heat exchanger;
feeding the refrigerant to a high-pressure side and to a low-pressure side of an auxiliary refrigerant/refrigerant heat exchanger for transferring heat from the high-pressure and high-temperature refrigerant flowing through the high-pressure side to the low-pressure and low-temperature refrigerant flowing through the low-pressure side.

Furthermore and preferably, though not necessarily, said refrigerant cooling means or refrigerant flow-rate adjusting means are controlled so as to selectively maintain between 0.7 and 1.2 the value of the “thermodynamic quality ratio” of the refrigerant at refrigerant-outlet of said first heat exchanger; the “thermodynamic quality ratio” of the refrigerant being defined by the equation:

$$TQ = \frac{H - {H}_{sat}^{L}}{{H}_{sat}^{V} - {H}_{sat}^{L}}$$

wherein H is the current Enthalpy of the refrigerant at refrigerant-outlet of the first heat exchanger; Hₛₐₜ^{L} is the Enthalpy of the refrigerant when in Saturated Liquid Condition at current pressure of the refrigerant; and Hₛₐₜ^{V} is the Enthalpy of the refrigerant when in Saturated Vapor Condition at current pressure of the refrigerant.

Furthermore and preferably, though not necessarily, said refrigerant cooling means or refrigerant flow-rate adjusting means are controlled so as to selectively maintain between 0.7 and 1.15, or between 1 and 1.15, the “thermodynamic quality ratio” of the refrigerant at refrigerant-outlet of the first heat exchanger.

Furthermore and preferably, though not necessarily, said refrigerant cooling means or refrigerant flow-rate adjusting means are controlled so as to selectively maintain between 0.7 and 1.07 or between 1 and 1.07, the “thermodynamic quality ratio” of the refrigerant at refrigerant-outlet of the first heat exchanger.

Furthermore and preferably, though not necessarily, said refrigerant cooling means or refrigerant flow-rate adjusting means are controlled so as to selectively maintain between 0.7 and 1.03, or between 1 and 1.03, the “thermodynamic quality ratio” of the refrigerant at refrigerant-outlet of the first heat exchanger.

Furthermore and preferably, though not necessarily, said at least one physical quantity is the temperature and/or pressure of the refrigerant at refrigerant-inlet or at refrigerant-outlet of said first air/refrigerant heat exchanger; and/or the temperature rise or drop of the refrigerant flowing through said first air/refrigerant heat exchanger.

Furthermore and preferably, though not necessarily, said at least one physical quantity is the temperature and/or pressure of the refrigerant at low-pressure refrigerant inlet or at low-pressure refrigerant outlet of the low-pressure side of said refrigerant/refrigerant heat exchanger; and/or the temperature and/or pressure of the refrigerant at high-pressure refrigerant inlet or at high-pressure refrigerant outlet of the high-pressure side of said refrigerant/refrigerant heat exchanger; and/or the temperature rise of the refrigerant flowing through the low-pressure side of said refrigerant/refrigerant heat exchanger; and/or the temperature drop of the refrigerant flowing through the high-pressure side of said refrigerant/refrigerant heat exchanger

Furthermore and preferably, though not necessarily, said at least one physical quantity is the temperature and/or pressure of the refrigerant at suction and/or at delivery of said refrigerant compressing device.

Furthermore and preferably, though not necessarily, said at least one physical quantity is the temperature and/or pressure of the refrigerant at refrigerant inlet or at refrigerant outlet of said second air/refrigerant heat exchanger. Furthermore and preferably, though not necessarily, said at least one physical quantity is the temperature and/or moisture degree of the airflow entering into, or coming out of, said laundry container.

Furthermore and preferably, though not necessarily, the step of measuring the current value of said at least one physical quantity comprises the step of measuring the current pressure and temperature of the refrigerant at refrigerant-outlet of the first heat exchanger; and in that the step of controlling said refrigerant cooling means or refrigerant flow-rate adjusting means comprises the step of calculating the saturation temperature of the refrigerant on the basis of the current refrigerant pressure, and the step of driving said refrigerant cooling means or refrigerant flow-rate adjusting means so as to keep the temperature of the refrigerant at refrigerant-outlet of said first heat exchanger within a predetermined first temperature range encompassing the calculated refrigerant saturation temperature.

Furthermore and preferably, though not necessarily, the step of driving refrigerant cooling means or refrigerant flow-rate adjusting means comprises the step of either
increasing the “thermodynamic quality ratio” of the refrigerant at refrigerant-outlet of the first heat exchanger (13), when the difference between the measured refrigerant temperature and the calculated refrigerant saturation temperature goes below the lower limit of said first temperature range, or
reducing said “thermodynamic quality ratio” when the difference between the measured refrigerant temperature and the calculated refrigerant saturation temperature rises above the upper limit of said first temperature range.

Furthermore and preferably, though not necessarily, the step of measuring the current value of said at least one physical quantity comprises the step of measuring the current pressure and temperature of the refrigerant at low-pressure refrigerant outlet of said refrigerant/refrigerant heat exchanger; and in that the step of controlling said refrigerant cooling means or refrigerant flow-rate adjusting means comprises the step of calculating the saturation temperature of the refrigerant on the basis of the current refrigerant pressure, and the step of driving said refrigerant cooling means or refrigerant flow-rate adjusting means so as to keep the temperature of the refrigerant at low-pressure refrigerant outlet of the auxiliary refrigerant/refrigerant heat exchanger within a predetermined second temperature range located above said refrigerant saturation temperature.

Furthermore and preferably, though not necessarily, the step of driving said refrigerant cooling means or refrigerant flow-rate adjusting means comprises the step of either
increasing the “thermodynamic quality ratio” of the refrigerant at refrigerant-outlet of the first heat exchanger, when the difference between the refrigerant temperature measured at low-pressure refrigerant outlet of the refrigerant/refrigerant heat exchanger and the calculated refrigerant saturation temperature goes below the lower limit of said second temperature range, or
reducing said “thermodynamic quality ratio” when the difference between the refrigerant temperature measured at low-pressure refrigerant outlet of the refrigerant/refrigerant heat exchanger and the calculated refrigerant saturation temperature exceeds the upper limit of said second temperature range.

Furthermore and preferably, though not necessarily, the step of measuring the current value of said at least one physical quantity comprises the steps of measuring the temperature rise of the refrigerant flowing through the low-pressure side of said refrigerant/refrigerant heat exchanger, and of measuring the temperature drop of the refrigerant flowing through the high-pressure side of said refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the difference between the temperature rise of the refrigerant flowing in the low-pressure side of the refrigerant/refrigerant heat exchanger and the temperature drop of the refrigerant flowing in the high-pressure side of the refrigerant/refrigerant heat exchanger, within a predetermined third temperature range.

Furthermore and preferably, though not necessarily, the step of driving said refrigerant cooling means or refrigerant flow-rate adjusting means comprises the step of either
reducing the “thermodynamic quality ratio” of the refrigerant at refrigerant-outlet of the first heat exchanger, when the temperature drop of the refrigerant flowing in the high-pressure side of the refrigerant/refrigerant heat exchanger exceeds of a predetermined first tolerance value the temperature rise of the refrigerant flowing in the low-pressure side of said refrigerant/refrigerant heat exchanger, or
increasing said “thermodynamic quality ratio” when the temperature drop of the refrigerant flowing in high-pressure side of said refrigerant/refrigerant heat exchanger exceeds of a predetermined second tolerance value the temperature rise of the refrigerant flowing in the low-pressure side of said refrigerant/refrigerant heat exchanger.

Furthermore and preferably, though not necessarily, the step of measuring the current value of said at least one physical quantity comprises the step of measuring the temperature rise or drop of the refrigerant flowing through the first air/refrigerant heat exchanger; and in that the step of controlling said refrigerant cooling means or refrigerant flow-rate adjusting means comprises the step of driving said refrigerant cooling means or refrigerant flow-rate adjusting means so as to keep the temperature rise or drop of the refrigerant flowing through said first air/refrigerant heat exchanger within a predetermined fourth temperature range.

Furthermore and preferably, though not necessarily, said fourth temperature range is included among −10° C. and +15° C.

Furthermore and preferably, though not necessarily, the step of driving said refrigerant cooling means or refrigerant flow-rate adjusting means comprises the step of either
increasing the “thermodynamic quality ratio” of the refrigerant at refrigerant-outlet of the first heat exchanger, when the temperature rise or drop of the refrigerant flowing through the first air/refrigerant heat exchanger goes below the lower limit of said fourth temperature range, or
reducing said “thermodynamic quality ratio” when the temperature rise or drop of the refrigerant flowing through the first air/refrigerant heat exchanger exceeds the upper limit of said fourth temperature range.

Furthermore and preferably, though not necessarily, the step of measuring the current value of said at least one physical quantity comprises also the step of measuring the temperature drop of the refrigerant flowing through the high-pressure side of said refrigerant/refrigerant heat exchanger; and in that the step of controlling said refrigerant cooling means or refrigerant flow-rate adjusting means comprises also the step of driving said refrigerant cooling means or refrigerant flow-rate adjusting means so as to also keep the temperature drop of the refrigerant flowing through the high-pressure side of the refrigerant/refrigerant heat exchanger within a fifth temperature range.

Furthermore and preferably, though not necessarily, the step of driving said refrigerant cooling means or refrigerant flow-rate adjusting means comprises the step of either
reducing the “thermodynamic quality ratio” of the refrigerant at refrigerant-outlet of the first heat exchanger, when the temperature rise or drop of the refrigerant flowing through the first air/refrigerant heat exchanger exceeds the upper limit of said fourth temperature range, and the temperature drop of the refrigerant flowing through the high-pressure side of said refrigerant/refrigerant heat exchanger goes below the lower limit of said fifth threshold value; or
increasing said “thermodynamic quality ratio” when the temperature rise or drop of the refrigerant flowing through the first air/refrigerant heat exchanger goes below the lower limit of said fourth temperature range, and the temperature drop of the refrigerant flowing through the high-pressure side of the refrigerant/refrigerant heat exchanger exceeds the upper limit of said fifth threshold value.

Furthermore and preferably, though not necessarily, the step of measuring the current value of said at least one physical quantity comprises also the step of measuring the temperature rise of the refrigerant flowing through the low-pressure side of said refrigerant/refrigerant heat exchanger; and in that the step of controlling said refrigerant cooling means or refrigerant flow-rate adjusting means comprises also the step of driving said refrigerant cooling means or refrigerant flow-rate adjusting means so as to also keep the temperature rise of the refrigerant flowing through the low-pressure side of said refrigerant/refrigerant heat exchanger within a sixth temperature range whose upper and lower ends are located above that of said fourth temperature range.

Furthermore and preferably, though not necessarily, step of driving said refrigerant cooling means or refrigerant flow-rate adjusting means comprises the step of either
reducing the “thermodynamic quality ratio” of the refrigerant at refrigerant-outlet of the first heat exchanger, when the temperature rise or drop of the refrigerant flowing through the first air/refrigerant heat exchanger exceeds the upper limit of said fourth temperature range, and the temperature rise of the refrigerant flowing through the low-pressure side of the refrigerant/refrigerant heat exchanger exceeds the upper limit of said sixth threshold value; or
increasing said “thermodynamic quality ratio” when the temperature rise or drop of the refrigerant flowing through the first air/refrigerant heat exchanger goes below the lower limit of said fourth temperature range, and the temperature rise of the refrigerant flowing through the low-pressure side of the refrigerant/refrigerant heat exchanger goes below the lower limit of said sixth threshold value.

Furthermore and preferably, though not necessarily, the step of measuring the current value of said at least one physical quantity comprises the step of measuring the temperature drop of the refrigerant flowing through the high-pressure side of said refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the temperature drop of the refrigerant flowing through the high-pressure side of the refrigerant/refrigerant heat exchanger within a seventh temperature range.

Furthermore and preferably, though not necessarily, the step of measuring the current value of said at least one physical quantity comprises the step of measuring the temperature rise of the refrigerant flowing through the low-pressure side of said refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the temperature rise of the refrigerant flowing through the low-pressure side of the refrigerant/refrigerant heat exchanger within a eighth temperature range.

Furthermore and preferably, though not necessarily, the step of measuring the current value of said at least one physical quantity comprises the step of measuring the refrigerant temperature at low-pressure refrigerant outlet of the refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the refrigerant temperature at low-pressure refrigerant outlet of said refrigerant/refrigerant heat exchanger within a predetermined ninth temperature range.

Furthermore and preferably, though not necessarily, the step of measuring the current value of said at least one physical quantity comprises the step of measuring the refrigerant temperature at refrigerant inlet of the second air/refrigerant heat exchanger; and in that the step of controlling said refrigerant cooling means or refrigerant flow-rate adjusting means comprises the step of driving said refrigerant cooling means or refrigerant flow-rate adjusting means so as to keep the refrigerant temperature at refrigerant inlet of said second air/refrigerant heat exchanger within a predetermined tenth temperature range.

Furthermore and preferably, though not necessarily, the step of measuring the current value of said at least one physical quantity comprises the step of measuring the refrigerant temperature at delivery of the refrigerant compressing device; and in that the step of controlling said refrigerant cooling means or refrigerant flow-rate adjusting means comprises the step of driving said refrigerant cooling means or refrigerant flow-rate adjusting means so as to keep the refrigerant temperature at delivery of said refrigerant compressing device within a predetermined tenth temperature range.

Furthermore and preferably, though not necessarily, the step of measuring the current value of said at least one physical quantity comprises the step of measuring the refrigerant temperature at high-pressure refrigerant inlet of the refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the refrigerant temperature at high-pressure refrigerant inlet of said refrigerant/refrigerant heat exchanger within a predetermined eleventh temperature range.

Furthermore and preferably, though not necessarily, the step of measuring the current value of said at least one physical quantity comprises the step of measuring the refrigerant temperature at high-pressure refrigerant outlet of the refrigerant/refrigerant heat exchanger; and in that the step of controlling said refrigerant cooling means or refrigerant flow-rate adjusting means comprises the step of driving said refrigerant cooling means or refrigerant flow-rate adjusting means so as to keep the refrigerant temperature at high-pressure refrigerant outlet of said refrigerant/refrigerant heat exchanger within a predetermined twelfth temperature range.

Furthermore and preferably, though not necessarily, the step of measuring the current value of said at least one physical quantity comprises the step of measuring the temperature of the airflow entering into the laundry container; and in that the step of controlling said refrigerant cooling means or refrigerant flow-rate adjusting means comprises the step of driving said refrigerant cooling means or refrigerant flow-rate adjusting means so as to keep the temperature of said airflow within a predetermined thirteenth temperature range.

### BRIEF DESCRIPTION OF THE DRAWINGS

A non-limiting embodiment of the present invention will now be described, by way of example, with reference to the accompanying drawings, in which:

FIG. 1 shows a lateral view, with parts in section and parts removed for clarity, of a rotary-drum home laundry dryer realized in accordance with the teachings of one embodiment of the present invention;

FIG. 2 shows a schematic view of the structure of the closed-circuit, heat-pump type, hot-air generator of the FIG. 1 rotary-drum home laundry dryer;

FIG. 3 is the Pressure-Enthalpy chart of the refrigerant used in the heat-pump assembly of the FIG. 2 hot-air generator, and disclosing a first working curve of the closed thermodynamic cycle implemented by the heat-pump assembly of the FIG. 2 hot-air generator;

FIG. 4 is the Pressure-Enthalpy chart of the refrigerant used in the heat-pump assembly of the FIG. 2 hot-air generator, and disclosing a second working curve of the closed thermodynamic cycle implemented by the heat-pump assembly of the FIG. 2 hot-air generator; whereas

FIG. 5 is the Pressure-Enthalpy chart of the refrigerant used in a second embodiment of the heat-pump assembly of the FIG. 2 hot-air generator, and disclosing a third working curve of the closed thermodynamic cycle implemented by said second embodiment of the heat-pump assembly.

### DETAILED DESCRIPTION OF EXAMPLE EMBODIMENTS

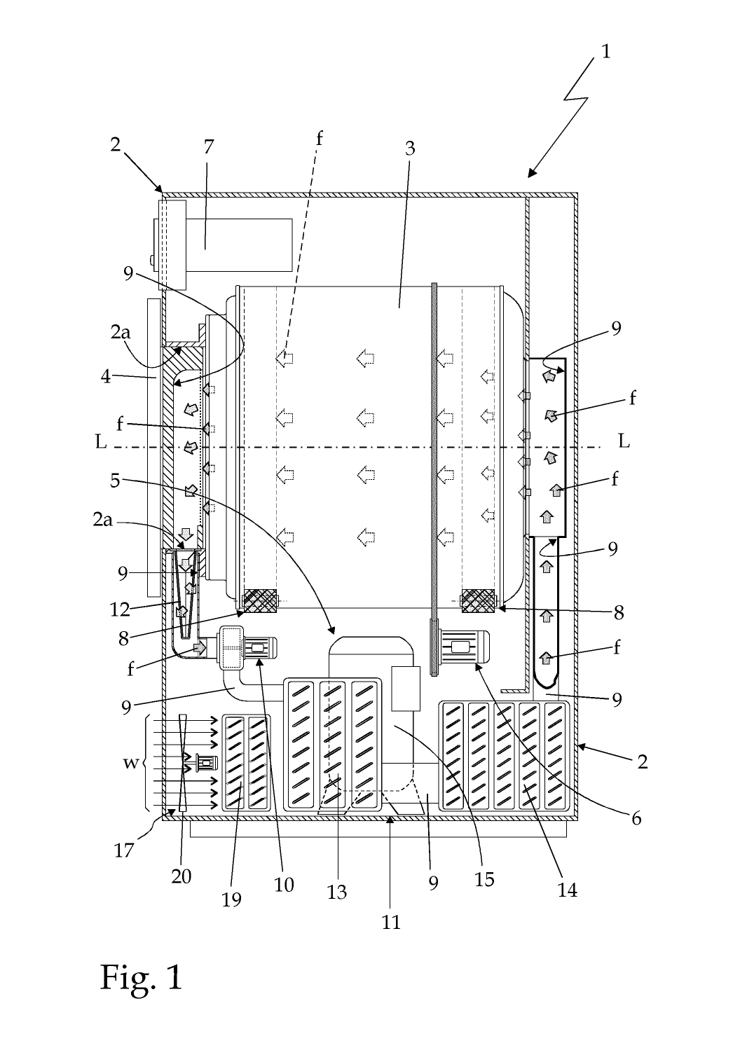

With reference to FIG. 1, number 1 indicates as a whole a heat-pump type, home laundry dryer which comprises:
a preferably, though not necessarily, parallelepiped-shaped outer boxlike casing 2 configured to rest on the floor;
a laundry container 3 which is configured to internally house the laundry to be dried, and which is located inside the outer casing 2, directly facing a laundry loading/unloading through opening 2a preferably, though not necessarily, realized in the front wall of casing 2;
a porthole door 4 hinged to the front wall of casing 2 to rotate about a preferably, though not necessarily, vertically-oriented reference axis, to and from a closing position in which door 4 rests completely against the front wall to close the laundry loading/unloading opening 2a and airtight seal the laundry container drum 3; and
a heat-pump type, closed-circuit, hot-air generator 5 which is located inside the outer casing 2 preferably, though not necessarily, beneath laundry container 3, and it is configured to circulate through the laundry container 3 a stream of hot air having a low moisture level, and which flows over and rapidly dries the laundry left inside the laundry container 3.

In other words, heat-pump type, closed-circuit hot-air generator 5 provides for gradually drawing air from laundry container 3; extracting and retaining the surplus moisture from the hot air drawn from laundry container 3; heating the dehumidified air to a predetermined temperature, normally higher than or equal to the temperature of the air arriving from laundry container 3; and feeding the heated, dehumidified air back into laundry container 3, where it flows over, to rapidly dry, the laundry inside the container.

Hot-air generator 5, therefore, provides for continuously dehumidifying and heating the air circulating inside laundry container 3 to rapidly dry the laundry inside the container.

With reference to FIG. 1, in the example shown, in particular, laundry dryer 1 is preferably a rotary-drum, heat-pump type, home laundry dryer, therefore laundry container 3 consists in a substantially cylindrical, hollow revolving drum 3 which is configured to internally house the laundry to be dried, and which is fixed in axially rotating manner inside the outer casing 2, directly facing the laundry loading/unloading through opening 2a formed in the front wall of casing 2.

Inside outer casing 2, the rotary-drum home laundry dryer 1 additionally comprises an electrically-powered motor assembly 6 which is configured to drive into rotation the revolving drum 3 about its longitudinal axis; and an electronic central control unit 7 which controls both the electrically-powered motor assembly 6 and the hot-air generator 5 to perform one of the user-selectable drying cycles preferably, though not necessarily, stored in the same central control unit.

With reference to FIG. 1, in the example shown the revolving drum 3 preferably, thought not necessarily, extends inside casing 2 coaxial to a substantially horizontally-oriented longitudinal axis L, and preferably, thought not necessarily, consists of a substantially cylindrical, rigid tubular body 3 which rests substantially horizontally inside the casing 2 on a number of substantially horizontally-oriented supporting rollers 8 which are located at both axial ends of tubular body 3, and are fixed to the casing 2 in free revolving manner so as to allow the tubular body 3 to freely rotate inside the casing about its horizontally-oriented longitudinal axis L.

Front rim of tubular body 3 is coupled in substantially airtight manner and in axially rotating manner to the front wall of the outer casing 2, so as to surround the laundry loading/unloading opening 2a present on that wall; whereas rear rim of tubular body 3 is preferably, thought not necessarily, coupled in substantially airtight manner and in axially rotating manner to an inner bulkhead parallel and spaced to the rear wall of the outer casing 2.

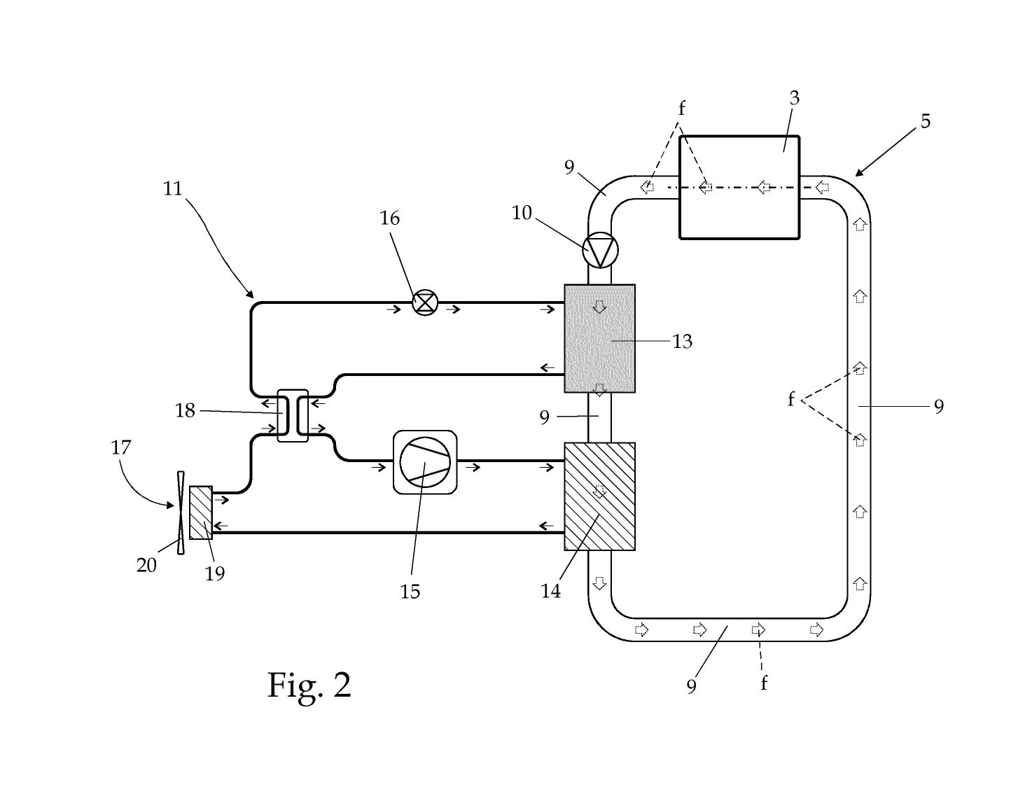

With reference to FIGS. 1 and 2, in some embodiments the heat-pump type, closed-circuit hot-air generator 5 comprises:
an air recirculating conduit 9, the two ends of which are connected to the revolving drum 3 on opposite sides of the latter;
an electrically-powered centrifugal fan 10 or other type of air circulating pump, which is located along the air recirculating conduit 9 to produce, inside the air recirculating conduit 9, an airflow f which flows through revolving drum 3 and over the laundry located inside drum 3; and
a heat-pump assembly 11 which is able to rapidly cool the airflow f coming out from revolving drum 3 for condensing and retaining the surplus moisture in the airflow f, and then to rapidly heat the airflow f returning back into revolving drum 3, so that the airflow f re-entering into revolving drum 3 is heated rapidly to a temperature higher than or equal to that of the airflow f coming out of the drum.

With reference to FIG. 1, in the example shown, in particular, the bulkhead portion aligned to the rear rim of tubular body 3 is perforated, or at any rate permeable to air, so to permit air entry into the rear rim of tubular body 3, and a first end of the air recirculating conduit 9 is coupled in airtight manner directly to the perforated portion of the inner bulkhead. The second end of air recirculating conduit 9, instead, is integrated into porthole door 4, and is faced to the front rim of tubular body 3 when door 4 is placed in the closing position.

Centrifugal fan 10, in turn, is designed to produce an airflow f which flows, along air recirculating conduit 9, from the door 4 to the perforated portion of the inner bulkhead of casing 2.

With reference to FIG. 1, preferably, though not necessarily, hot-air generator 5 is also provided with a manually-removable filtering device 12 which is located along air recirculating conduit 9, upstream of the heat-pump assembly 11 and preferably also of centrifugal fan 10, and which is configured to stop fluff and/or lint particles upstream of heat-pump assembly 11 or even centrifugal fan 10.

With reference to FIGS. 1 and 2, the heat-pump assembly 11 in some embodiments comprises:
a first air/refrigerant heat exchanger 13 which is located along the air recirculating conduit 9, preferably, thought not necessarily, downstream of centrifugal fan 10, and which is configured to rapidly cool down the airflow f arriving from revolving drum 3 to condense and restrain the surplus moisture in the airflow f;
a second air/refrigerant heat exchanger 14 which is located along the air recirculating conduit 9, downstream of heat exchanger 13, and which is configured to rapidly heat the airflow f arriving from heat exchanger 13 and directed back to revolving drum 3, so that the airflow f re-entering into revolving drum 3 is heated rapidly to a temperature higher than or equal to that of the air flowing out of revolving drum 3;
an electrically-powered refrigerant compressing device 15 which is interposed between the refrigerant-outlet of heat exchanger 13 and the refrigerant-inlet of heat exchanger 14, and which is configured to compress the gaseous-state refrigerant directed towards heat exchanger 14 so that refrigerant pressure and temperature are much higher at the refrigerant-inlet of heat exchanger 14 than at the refrigerant-outlet of heat exchanger 13; and
an expansion valve 16 or similar passive/operated refrigerant expansion device (for example a capillary tube, a thermostatic valve or an electrically-controlled expansion valve) which is interposed between the refrigerant-outlet of heat exchanger 14 and the refrigerant-inlet of heat exchanger 13, and is configured so as to cause a rapid expansion of the refrigerant directed towards the first heat exchanger 13, so that refrigerant pressure and temperature are much higher at the refrigerant-outlet of heat exchanger 14 than at the refrigerant-inlet of heat exchanger 13.

The air/refrigerant heat exchanger 13 is conventionally referred to as the “evaporator” or the “gas heater” (the latter in case the refrigerant operates at supercritical pressure) of supercritical mode of the heat-pump assembly, and it is configured so that the airflow f arriving from revolving drum 3 and the low-pressure and low-temperature refrigerant directed to the suction of the refrigerant compressing device 15 can flow through it simultaneously, allowing the refrigerant having a temperature lower than that of the airflow f, to absorb heat from the airflow f, thus causing condensation of the surplus moisture in the airflow f arriving from revolving drum 3.

The air/refrigerant heat exchanger 14, in turn, is conventionally referred to as the “condenser” or the “gas cooler” (the latter in case the refrigerant operates at supercritical pressure) of the heat-pump assembly, and it is configured so that the airflow f directed back into revolving drum 3 and the high-pressure and high-temperature refrigerant arriving from the delivery of the refrigerant compressing device 15 can flow through it simultaneously, allowing the refrigerant having a temperature greater than that of the airflow f to release heat to the airflow f, thus rapidly heating the airflow f directed back into the revolving drum 3.

In addition to the above, differently from today's home laundry dyers, the heat-pump assembly 11 moreover comprises:
refrigerant thermodynamic-parameters adjusting means 17 which are configured to adjust the current temperature of the low-pressure refrigerant coming out of the refrigerant-outlet of evaporator 13; and
an auxiliary internal refrigerant/refrigerant heat exchanger 18 which has a high-pressure side through which flows the high-pressure refrigerant directed towards the refrigerant expansion valve 16, and a low-pressure side through which flows the low-pressure refrigerant coming out of the first heat exchanger 13 directed to the suction of refrigerant compressing device 15, and which is configured so that the high- and low-pressure sides are terminally coupled one another to allow heat transfer from the high-pressure and high-temperature refrigerant to the low-pressure and low-temperature refrigerant.

In other words, internal heat exchanger 18 is preferably crossed, at the same time, by the high-pressure and high-temperature refrigerant directed towards the refrigerant expansion valve 16, and by the low-pressure and low-temperature refrigerant coming out of the refrigerant-outlet of heat exchanger 13 directed to the suction of refrigerant compressing device 15, and it is configured to transfer heat from the high-pressure and high-temperature refrigerant to the low-pressure and low-temperature refrigerant, so to heat up the low-pressure and low-temperature refrigerant before the latter reaches the suction of refrigerant compressing device 15.

Internal heat exchanger 18, therefore, is configured to transfer heat from the high-pressure side of the heat-pump assembly 11, to the low-pressure side of the same heat-pump assembly 11.

In particular, the internal heat exchanger 18 is preferably configured so that the refrigerant flowing in the high-pressure side and the refrigerant flowing in the low-pressure side flow in counter-current configuration.

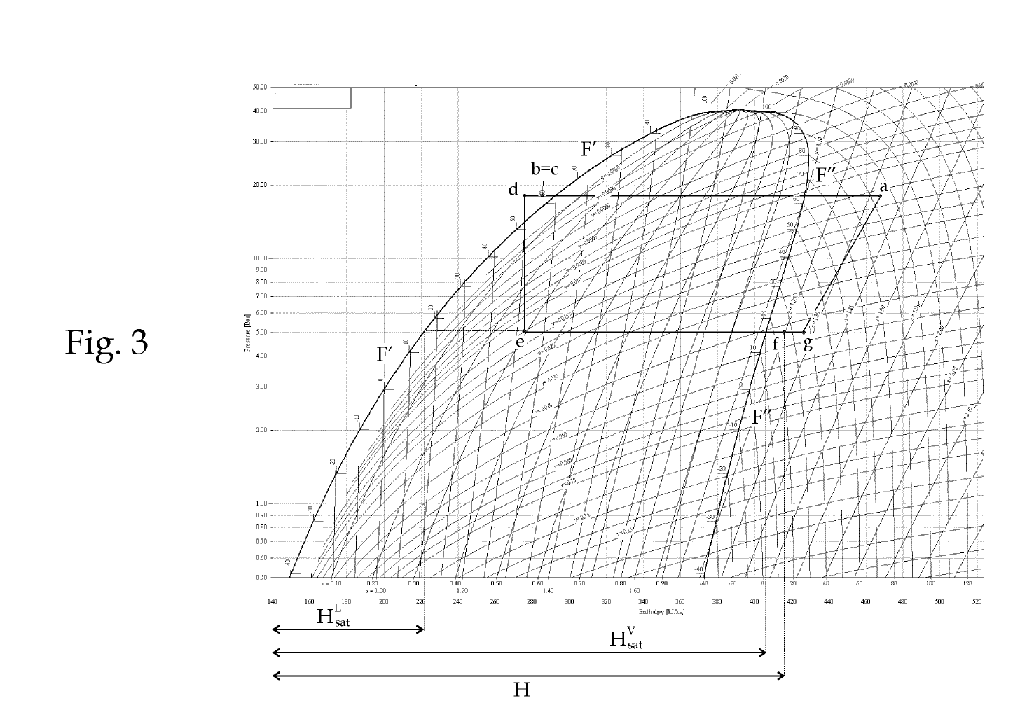

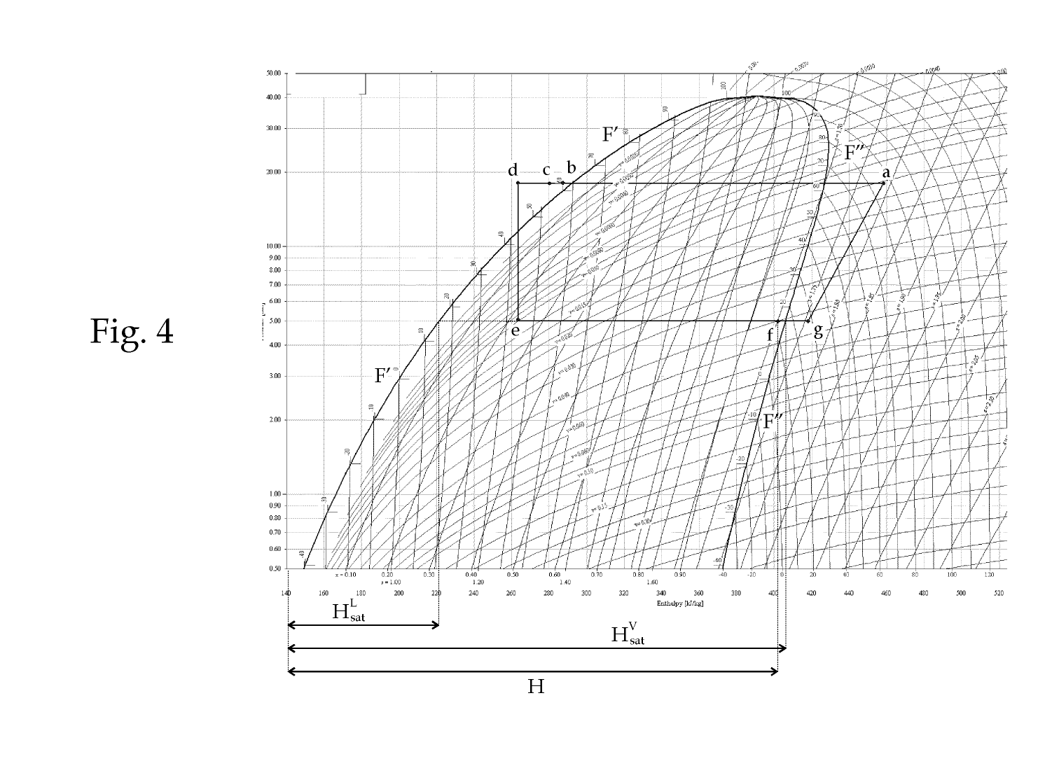

With reference to FIGS. 3 and 4, central control unit 7 of laundry dryer 1, in turn, is additionally configured/programmed to control the refrigerant thermodynamic-parameters adjusting means 17 according to the time-progression of at least one physical quantity measured within the laundry dyer 1, so to continuously adjust/vary the temperature of the refrigerant at refrigerant-outlet of evaporator 13 (i.e. at refrigerant-outlet of the air/refrigerant heat exchanger 13), for selectively maintaining between 0.7 and 1.2 the average value of the “thermodynamic quality ratio” TQ of the refrigerant coming out of the refrigerant-outlet of evaporator 13, i.e. of air/refrigerant heat exchanger 13; the “thermodynamic quality ratio” TQ of the refrigerant being defined by the following equation:

$$TQ = \frac{H - {H}_{sat}^{L}}{{H}_{sat}^{V} - {H}_{sat}^{L}}$$

wherein H is the current Enthalpy of the refrigerant at refrigerant-outlet of evaporator 13; Hₛₐₜ^{L} is the Enthalpy of the refrigerant when in Saturated Liquid Condition at current pressure of the refrigerant, i.e. the Enthalpy value on the refrigerant Saturated Liquid Curve F′, at a refrigerant pressure corresponding to that of the refrigerant at refrigerant-outlet of evaporator 13; and Hₛₐₜ^{V} is the Enthalpy of the refrigerant when in Saturated Vapor Condition at current pressure of the refrigerant, i.e. the Enthalpy value on the refrigerant Saturated Vapor Curve F″, at a refrigerant pressure corresponding to that of the refrigerant at refrigerant-outlet of heat exchanger 13.

In particular, central control unit 7 of laundry dryer 1 is preferably configured/programmed to control the refrigerant thermodynamic-parameters adjusting means 17 so as to keep, when hot-air generator 5 is preferably in the steady-state working phase, the “thermodynamic quality ratio” TQ of the refrigerant coming out of the refrigerant-outlet of evaporator 13 within a predetermined operative range preferably, though not necessarily, encompassed between 0.7 and 1.15, or between 0.7 and 1.07, or even between 0.7 and 1.03. As an alternative, central control unit 7 may be configured/programmed to control the refrigerant thermodynamic-parameters adjusting means 17 so as to keep, when hot-air generator 5 is preferably in the steady-state working phase, the average value of the “thermodynamic quality ratio” TQ of the refrigerant coming out of the refrigerant-outlet of evaporator 13 within a predetermined operative range preferably, though not necessarily, encompassed between 1 and 1.2, or between 1 and 1.15, or between 1 and 1.07, or even between 1 and 1.03.

Internal heat exchanger 18, in turn, is dimensioned to rapidly heat up the low-pressure refrigerant coming out of evaporator 13, so to ensure that the refrigerant coming out of the low-pressure refrigerant outlet of internal heat exchanger 18 and directed towards the suction of refrigerant compressing device 15 is always completely in gaseous state and at-least-slightly superheated, i.e. it is located on the right side of the refrigerant Saturated Vapor Curve F″ on the Pressure-Enthalpy chart.

With reference to FIGS. 1 and 2, in the example shown, in particular, the refrigerant thermodynamic-parameters adjusting means 17 preferably, though not necessarily, comprise a refrigerant cooling device 17 which is connected in series to the condenser 14, i.e. to the air/refrigerant heat exchanger 14, so to be crossed by the high-pressure and high-temperature refrigerant arriving from the condenser 14, and which is configured to selectively cool down the high-pressure refrigerant in addition to the condenser 14.

In the example shown, in particular, the refrigerant thermodynamic-parameters adjusting means 17 preferably, though not necessarily, comprise:
a third air/refrigerant heat exchanger 19 which is connected in series to the condenser 14, i.e. to the air/refrigerant heat exchanger 14, so to be crossed by the high-pressure and high-temperature refrigerant coming out from the refrigerant-outlet of condenser 14, and which is configured so as to cool down the high-pressure refrigerant directed towards the expansion valve 16, dissipating the heat in the outside environment; and
an electrically-powered auxiliary cooling fan 20 or other ventilation device, which is located inside the casing 2, close to the air/refrigerant heat exchanger 19, and it is configured so as to generate and channel a stream w of cooling air towards the body of the auxiliary air/refrigerant heat exchanger 19, so as to selectively maximize or minimize the heat-loss/cooling of the high-pressure and high-temperature refrigerant directed to the internal heat exchanger 18 and to the refrigerant expansion valve 16.

In a different non-shown embodiment, the auxiliary air/refrigerant heat exchanger 19 may be interposed between the high-pressure refrigerant outlet of internal heat exchanger 18 and the refrigerant expansion valve 16.

Central control unit 7 of laundry dryer 1 controls refrigerant cooling device 17, i.e. controls activation and deactivation of cooling fan 20, so to selectively maximize or minimize the cooling of the high-pressure refrigerant directed towards the refrigerant expansion valve 16, so as to continuously adjust/vary the temperature of the refrigerant at refrigerant-outlet of evaporator 13, i.e. of the air/refrigerant heat exchanger 13, form maintaining, when the hot-air generator 5 is preferably in the steady-state working phase, the average “thermodynamic quality ratio” TQ of the refrigerant coming out of refrigerant-outlet of evaporator 13 within a predetermined operative range encompassed between 0.7 and 1.2.

In the example shown, in particular, the auxiliary air/refrigerant heat exchanger 19 is preferably located downstream of condenser 14, i.e. between the refrigerant outlet of air/refrigerant heat exchanger 14 and the high-pressure side of refrigerant/refrigerant heat exchanger 18.

General operation of the rotary-drum home laundry dryer 1 is clearly inferable from the above description, with no further explanation required.

As regards operation of heat-pump assembly 11, the central control unit 7 of laundry dyer 1 controls the activation and/or the current revolving speed of cooling fan 20 so as to selectively maintain, when hot-air generator 5 is preferably in the steady-state working conditions, the temperature of the low-pressure refrigerant coming out of the evaporator 13 very close to the corresponding refrigerant saturation temperature.

In fact, the “thermodynamic quality ratio” TQ of the refrigerant is equal to 1 when the Enthalpy H of the refrigerant at refrigerant-outlet of evaporator 13 coincides with the Enthalpy Hₛₐₜ^{V} of the refrigerant when in Saturated Vapor Condition at current pressure of the refrigerant. According to well known thermodynamic laws, this condition occurs when the temperature of the refrigerant at refrigerant-outlet of evaporator 13 is equal to the corresponding refrigerant saturation temperature. The refrigerant saturation temperature, in fact, is the refrigerant temperature at which, for a given pressure of the refrigerant, the liquid-to-gaseous phase-change of the refrigerant is completed, and it is always located, in the Pressure-Enthalpy chart of the refrigerant, on the refrigerant Saturated Vapor Curve F″.

Instead the refrigerant/refrigerant heat exchanger 18 is configured to sequentially heat up the low-pressure and low-temperature refrigerant coming out of refrigerant-outlet of the evaporator 13, i.e. of the air/refrigerant heat exchanger 13, so as to perform the superheating of the low-pressure refrigerant directed towards the suction of refrigerant compressing device 15 and, if necessary, also the preliminary complete evaporation of the low-pressure refrigerant directed towards the suction of refrigerant compressing device 15.

In view of the above, central control unit 7 of laundry dryer 1 is preferably configured/programmed to firstly determine whether the hot-air generator 5 is either in warm-up phase or in steady-state working phase. This operation can be performed, for example, via a continuous control of the temperature of the airflow f entering into revolving drum 3, i.e. on exit from the condenser 14, or via a control of the time-progression of the refrigerant temperature and/or of the refrigerant pressure at refrigerant-outlet of the condenser 14. Also the moisture degree of the airflow f entering into or coming out of the revolving drum 3 could be used for determining whether the hot-air generator 5 is either in warm-up phase or in steady-state working phase.

In the steady-state working conditions, in fact, the temperature of the airflow f flowing through revolving drum 3 reaches the highest value and remains roughly constant to said highest value for several minutes, up to the end of the drying cycle.

Therefore, until the temperature of the airflow f at air-outlet of the condenser 14 is below a given first threshold value (for example below 50° C.), or until the temperature of the refrigerant at refrigerant-outlet of the condenser 14 is below a given second threshold value (for example below 40° C.), the central control unit 7 of laundry dryer 1 assumes that hot-air generator 5 is in the warm-up phase and keeps the cooling fan 20 switched-off, or at minimum revolving speed, to perform an intensive superheating of the refrigerant both in the evaporator 13, i.e. in the air/refrigerant heat exchanger 13, and in the auxiliary internal refrigerant/refrigerant heat exchanger 18, so as to rapidly increase the refrigerant temperature at suction of the refrigerant compressing device 15.

Instead, when the temperature of the airflow f at air-outlet of condenser 14 rises above said first threshold value (for example above 50° C.), or when the temperature of the refrigerant at refrigerant-outlet of condenser 14 rises above said second threshold value (for example above 40° C.), central control unit 7 of laundry dryer 1 assumes that hot-air generator 5 is in the steady-state working phase and controls activation and deactivation of cooling fan 20, or varies the revolving speed of cooling fan 20, so to selectively maintain the average “thermodynamic quality ratio” TQ of the refrigerant coming out of refrigerant-outlet of evaporator 13 within a predetermined operative range encompassed between 0.7 and 1.2.

In other words, central control unit 7 controls the activation and/or the current revolving speed of cooling fan 20, so as to selectively maintain the temperature of the low-pressure refrigerant coming out of the evaporator 13 within a narrow temperature range which encompasses the corresponding refrigerant saturation temperature.

In particular, in the example shown the central control unit 7 preferably continuously switches the cooling fan 20 on and off, or varies the revolving speed of cooling fan 20, so that the refrigerant coming out of refrigerant-outlet of heat exchanger 13 has an average “thermodynamic quality ratio” TQ preferably, though not necessarily, encompassed between 0.7 and 1.03; or preferably, though not necessarily, encompassed between 0.7 and 1.07; or preferably, though not necessarily, encompassed between 0.7 and 1.15; and in any case encompassed between 0.7 and 1.2. Alternatively, the average “thermodynamic quality ratio” TQ could be encompassed between 1 and 1.15, or between 1 and 1.07, or even between 1 and 1.03.

FIG. 3 shows the closed thermodynamic cycle performed by the heat-pump assembly 11 when cooling fan 20 is switched off.

With reference to FIG. 3, when coming out of the delivery of refrigerant compressing device 15, the high-pressure and high-temperature refrigerant enters into the condenser 14, i.e. into the air/refrigerant heat exchanger 14, wherein it gives off heat to the airflow f entering into revolving drum 3. Afterwards the high-pressure and high-temperature refrigerant enters into the auxiliary air/refrigerant heat exchanger 19, but, being the cooling fan 20 switched-off, the air/refrigerant heat exchanger 19 has substantially no cooling effects on the refrigerant flowing from the refrigerant-outlet of condenser 14 to the refrigerant expansion valve 16.

This implies that, in the high-pressure side of heat-pump assembly 11, the refrigerant gives off heat only to the airflow f entering into the revolving drum 3 with substantially no pressure drops, and therefore it moves from point a (delivery of refrigerant compressing device 15) to point b of the Pressure-Enthalpy chart (refrigerant inlet of auxiliary heat exchanger 19) along an approximately constant-pressure line, and afterwards it moves to point c of the Pressure-Enthalpy chart (high-pressure refrigerant inlet of heat exchanger 18) along the same approximately constant-pressure line.

Obviously, since auxiliary heat exchanger 19 has no cooling effects on the refrigerant flowing in the high-pressure side of heat pump assembly 11, points b of the Pressure-Enthalpy chart (refrigerant inlet of heat exchanger 19) substantially coincides to point c of the Pressure-Enthalpy chart (high-pressure refrigerant inlet of heat exchanger 18).

Afterwards the high-pressure and high-temperature refrigerant flows inside the refrigerant/refrigerant heat exchanger 18 with substantially no pressure drop, wherein it gives off heat to the low-pressure and low-temperature refrigerant flowing towards the suction of refrigerant compressing device 15, thus moving from point c (high-pressure refrigerant inlet of heat exchanger 18) to point d of the Pressure-Enthalpy chart (high-pressure refrigerant outlet of heat exchanger 18 and inlet of refrigerant expansion valve 16) again along a constant-pressure line. When coming out of air/refrigerant heat exchanger 19 or out of refrigerant/refrigerant heat exchanger 18, the refrigerant is completely in liquid state and therefore it is located on the left side of the refrigerant Saturated Liquid Curve F′ on the Pressure-Enthalpy chart.

This means that at least point d of the Pressure-Enthalpy chart is located on the left side of the refrigerant Saturated Liquid Curve F′.

When coming out of the refrigerant/refrigerant heat exchanger 18, the high-pressure and high-temperature refrigerant flows through the refrigerant expansion valve 16 which subjects the refrigerant to a substantially adiabatic rapid expansion, so as to cause a rapid drop of both refrigerant pressure and refrigerant temperature, and also the evaporation of part of the refrigerant. In this case, the refrigerant moves from point d (high-pressure refrigerant outlet of heat exchanger 18 and inlet of refrigerant expansion valve 16) to point e of the Pressure-Enthalpy chart (outlet of refrigerant expansion valve 16 and refrigerant-inlet of evaporator 13) along a substantially constant-Enthalpy line that crosses the refrigerant Saturated Liquid Curve F′.

After coming out of expansion valve 16, the low-pressure and low-temperature refrigerant flows inside the evaporator 13, i.e. the air/refrigerant heat exchanger 13, wherein it absorbs heat from the airflow f coming out of revolving drum 3 with substantially no pressure drop. In other words, inside the evaporator 13 the low-pressure and low-temperature refrigerant is allowed to absorb, from the airflow f arriving from revolving drum 3, a heat amount which suffices to perform a complete evaporation and a slight superheating of the refrigerant directed towards the suction of refrigerant compressing device 15.

In thermodynamic, a refrigerant is defined as being in a superheated condition when the temperature of the refrigerant is greater than the refrigerant saturation temperature at the current refrigerant pressure. This implies that a refrigerant in superheated condition is a refrigerant completely in gaseous state and it is located on the right side of the refrigerant Saturated Vapor Curve F″ on the Pressure-Enthalpy chart.

While flowing inside the evaporator 13, therefore, the refrigerant moves from point e (refrigerant-inlet of heat exchanger 13) to point f of the Pressure-Enthalpy chart (low-pressure refrigerant-inlet of refrigerant/refrigerant heat exchanger 18) along a substantially constant-Pressure line, and point f of the Pressure-Enthalpy chart (low-pressure refrigerant-inlet of internal refrigerant/refrigerant heat exchanger 18) is located on the right side of the refrigerant Saturated Vapor Curve F″.

When coming of the evaporator 13, i.e. from the air/refrigerant heat exchanger 13, the gaseous-state low-pressure and low-temperature refrigerant flows again inside the refrigerant/refrigerant heat exchanger 18 with substantially no pressure drops, wherein it absorbers heat from the high-pressure and high-temperature refrigerant flowing towards the inlet of refrigerant expansion vale 16, thus continuing its superheating process. While flowing inside the internal refrigerant/refrigerant heat exchanger 18, the gaseous-state refrigerant moves from point f (low-pressure refrigerant-inlet of internal refrigerant/refrigerant heat exchanger 18) to point g of the Pressure-Enthalpy chart (suction of the refrigerant compressing device 15) again along a constant-Pressure line.

After coming out of heat exchanger 18, the gaseous-state, low-pressure and low-temperature refrigerant enters in the refrigerant compressing device 15 wherein it is compressed so as to close the thermodynamic cycle, and moves from point g (suction of the refrigerant compressing device 15) back to point a the Pressure-Enthalpy chart (delivery of refrigerant compressing device 15) along an inclined Pressure-, and Enthalpy-increasing line.

FIG. 4 instead shows the closed thermodynamic cycle performed by the heat-pump assembly 11 when cooling fan 20 is switched on, i.e. when the refrigerant cooling device 17 cools down the refrigerant flowing from the condenser 14 to the refrigerant expansion device 16.

With reference to FIG. 4, in the same way to the previous thermodynamic cycle, when coming out of the delivery of refrigerant compressing device 15, the high-pressure and high-temperature refrigerant enters into the condenser 14, i.e. into the air/refrigerant heat exchanger 14, wherein it gives off heat to the airflow f directed into revolving drum 3 with substantially no pressure drop. The refrigerant, therefore, moves from point a (delivery of refrigerant compressing device 15) to point b of the Pressure-Enthalpy chart (refrigerant inlet of auxiliary heat exchanger 19) along a constant-pressure line alike the previous case.

Afterwards the high-pressure and high-temperature refrigerant enters into the auxiliary air/refrigerant heat exchanger 19, wherein, being the cooling fan 20 switched on, the refrigerant is cooled by a stream w of cooling air arriving from the outside of casing 2. The refrigerant, therefore, moves from point b (refrigerant inlet of heat exchanger 19) to point c of the Pressure-Enthalpy chart (high-pressure refrigerant inlet of heat exchanger 18) along the same constant-pressure line.

Due to the increased heat-loss, when coming out of the air/refrigerant heat exchanger 19, the refrigerant is completely in liquid state and it is located faraway on the left side of the refrigerant Saturated Liquid Curve F′ on the Pressure-Enthalpy chart. Thus point c is located faraway on the left side of the refrigerant Saturated Liquid Curve F′.

Afterwards the high-pressure and high-temperature refrigerant flows inside the refrigerant/refrigerant heat exchanger 18 with substantially no pressure drop, wherein it gives off heat to the low-pressure and low-temperature refrigerant flowing towards the suction of refrigerant compressing device 15, thus moving from point c (high-pressure refrigerant inlet of heat exchanger 18) to point d of the Pressure-Enthalpy chart (high-pressure refrigerant outlet of heat exchanger 18 and inlet of refrigerant expansion valve 16) again along a constant-pressure line.

When coming out of the refrigerant/refrigerant heat exchanger 18, the liquid-state, high-pressure and high-temperature refrigerant flows through the refrigerant expansion valve 16 which subjects the refrigerant to a substantially adiabatic rapid expansion, so as to cause a rapid drop of both refrigerant pressure and refrigerant temperature, and also the evaporation of part of the refrigerant. With reference to FIG. 4, the refrigerant, therefore, moves from point d (high-pressure refrigerant outlet of heat exchanger 18 and inlet of refrigerant expansion valve 16) to point e of the Pressure-Enthalpy chart (outlet of refrigerant expansion valve 16 and refrigerant-inlet of evaporator 13) along a substantially constant-Enthalpy line that crosses the refrigerant Saturated Liquid Curve F′.

After coming out of expansion valve 16, the low-pressure and low-temperature refrigerant flows inside the evaporator 13, i.e. the air/refrigerant heat exchanger 13, wherein it absorbs heat from the airflow f coming out of revolving drum 3 with substantially no pressure drop. In this case, being the refrigerant temperature at refrigerant-inlet of evaporator 13 significantly lower than that in the FIG. 3 closed thermodynamic cycle, the low-pressure and low-temperature refrigerant flowing along the evaporator 13 is able to absorb, from the airflow f arriving from revolving drum 3, an increased heat amount which is however insufficient to perform a complete evaporation of the refrigerant directed towards the suction of refrigerant compressing device 15.

Thus, when coming out of the evaporator 13, i.e. from the air/refrigerant heat exchanger 13, the low-pressure and low-temperature is still partly in liquid state, and it is located on the left side of the refrigerant Saturated Vapor Curve F″ on the Pressure-Enthalpy chart.

With reference to FIG. 4, while flowing inside the first air/refrigerant heat exchanger 13, therefore, the refrigerant moves from point e (refrigerant-inlet of heat exchanger 13) to point f of the Pressure-Enthalpy chart (low-pressure refrigerant-inlet of internal refrigerant/refrigerant heat exchanger 18) along a substantially constant-Pressure line, but point f is located on the left side of the refrigerant Saturated Vapor Curve F″ on the Pressure-Enthalpy chart.

When coming out of the evaporator 13, the liquid-gaseous double-phase, low-pressure and low-temperature refrigerant flows again inside the internal refrigerant/refrigerant heat exchanger 18 with substantially no pressure drop, wherein it absorbs, from the high-pressure and high-temperature refrigerant flowing towards the inlet of refrigerant expansion vale 16, a heat amount which suffices to complete evaporation of the refrigerant and afterwards to perform the superheating of the refrigerant directed towards the suction of refrigerant compressing device 15.

With reference to FIG. 4, while flowing inside the heat exchanger 18, the refrigerant therefore moves from point f (low-pressure refrigerant-inlet of internal heat exchanger 18) to point g of the Pressure-Enthalpy chart (suction of the refrigerant compressing device 15) along a constant-Pressure line that, in this case, crosses the refrigerant Saturated Vapor Curve F″ on the Pressure-Enthalpy chart.

At point g of the Pressure-Enthalpy chart, in fact, the refrigerant is completely in gaseous state and superheated, so to reach the suction of refrigerant compressing device 15 with no risks for the refrigerant compressing device 15.

As in the previous closed thermodynamic cycle, after coming out of heat exchanger 18, the gaseous-state, low-pressure and low-temperature refrigerant enters in the refrigerant compressing device 15, wherein it is compressed so as to close the thermodynamic cycle, and moves from point g (suction of refrigerant compressing device 15) back to point a the Pressure-Enthalpy chart (delivery of refrigerant compressing device 15) along an inclined Pressure-, and Enthalpy-increasing line.

As regards operation of central control unit 7, the central control unit 7 of laundry dryer 1 is configured/programmed to drive the refrigerant cooling device 17, i.e. to switch the cooling fan 20 on and off, so as to force the heat-pump assembly 11 to selectively and alternatively perform either the FIG. 3 closed thermodynamic cycle which produces, at refrigerant-outlet of evaporator 13, a refrigerant having a relatively high “thermodynamic quality ratio” (i.e. a “thermodynamic quality ratio” preferably, though not necessarily, greater than 1.2); or the FIG. 4 closed thermodynamic cycle which produces, at refrigerant-outlet of evaporator 13, a refrigerant having a relatively low “thermodynamic quality ratio” (i.e. a “thermodynamic quality ratio” preferably, though not necessarily, lower than 1 or even lower than 0.7).

The switching between the FIG. 3 thermodynamic cycle and the FIG. 4 thermodynamic cycle is purposely controlled so that the low-pressure refrigerant has, at refrigerant-outlet of evaporator 13 (i.e. at refrigerant-outlet of air/refrigerant heat exchanger 13), an average “thermodynamic quality ratio” TQ which is comprised between 0.7 and 1.2. As an alternative, the switching between the FIG. 3 thermodynamic cycle and the FIG. 4 thermodynamic cycle could be purposely controlled so that the low-pressure refrigerant has, at refrigerant-outlet of evaporator 13, an average “thermodynamic quality ratio” TQ which is comprised between 1 and 1.2.

In other words, central control unit 7 purposely controls the activation and/or the revolving speed of cooling fan 20, so as to maintain, preferably when the hot-air generator 5 is in the steady-state working phase, the average “thermodynamic quality ratio” TQ of the low-pressure refrigerant coming out of evaporator 13 within a predetermined operative range encompassed between 0.7 and 1.2, or alternatively between 1 and 1.2.

In the example shown, in particular, central control unit 7 is configured/programmed to switch the cooling fan 20 on and off, or to vary the revolving speed of cooling fan 20, so as to maintain the average “thermodynamic quality ratio” TQ of the low-pressure refrigerant coming out of evaporator 13 within a predetermined operative range which is preferably, though not necessarily, encompassed between 0.7 and 1.15; or is preferably, though not necessarily, encompassed between 0.7 and 1.07; or is even preferably, though not necessarily, encompassed between 0.7 and 1.03.

As an alternative, the predetermined operative range for the average “thermodynamic quality ratio” TQ could be encompassed between 1 and 1.15, or between 1 and 1.07, or even between 1 and 1.03.

More in particular, the central control unit 7 of laundry dryer 1 preferably, though not necessarily, implements a control strategy which tries to maintain, when hot-air generator 5 is preferably in the steady-state working phase, the temperature of the refrigerant at refrigerant-outlet of evaporator 13 very close to the corresponding refrigerant saturation temperature, so that the average “thermodynamic quality ratio” TQ of the low-pressure refrigerant coming out of evaporator 13 varies around 1, i.e. is encompassed between 0.7 and 1.2.

In fact, according to well known thermodynamic laws and with reference to refrigerant zeotropic blends, the refrigerant saturation temperature is the refrigerant temperature at which, for a given pressure of the refrigerant, the liquid-to-gaseous phase-change of the refrigerant is completed. Therefore, if the temperature of the refrigerant at refrigerant-outlet of evaporator 13 is very close to the corresponding refrigerant saturation temperature (either on the right side or on the left side of the refrigerant Saturated Vapor Curve F″), it implies that the Enthalpy H of the refrigerant at refrigerant-outlet of evaporator 13 (i.e. the Enthalpy H of the refrigerant at Point f on the Pressure-Enthalpy chart) is approximately equal to the Enthalpy Hₛₐₜ^{V} of the refrigerant when in Saturated Vapor Condition at current pressure of the refrigerant.

Thus, if the temperature of the low-pressure refrigerant at refrigerant-outlet of evaporator 13 is very close to the corresponding refrigerant saturation temperature, the “thermodynamic quality ratio” TQ of the refrigerant at refrigerant-outlet of evaporator 13 is very close to 1, and therefore is encompassed between 0.7 and 1.2.

In view of the above, taking into consideration that the refrigerant saturation temperature is a scalar physical quantity which depends strictly on the type of the refrigerant in use and which can be easily calculated on the basis of the pressure-Enthalpy chart specific for said refrigerant, central control unit 7 of laundry dryer 1 maintains, when hot-air generator 5 is in the steady-state working phase, the “thermodynamic quality ratio” TQ of the refrigerant at refrigerant-outlet of evaporator 13 between 1.7 and 1.2, via a selected activation and deactivation of cooling fan 20 on the basis of the refrigerant temperature and refrigerant pressure measured at refrigerant-outlet of the evaporator 13, i.e. of the air/refrigerant heat exchanger 13.

In other words, central control unit 7 of laundry dryer 1 firstly measures the current pressure and temperature of the refrigerant at refrigerant-outlet of heat exchanger 13; then calculates the exact refrigerant saturation temperature on the basis of the measured current refrigerant pressure; and finally compares the measured refrigerant temperature with the calculated refrigerant saturation temperature so as to determine whether the calculated refrigerant saturation temperature is greater than the measured refrigerant temperature.

In view of the measured refrigerant temperature being either higher or lower that the calculated refrigerant saturation temperature, central control unit 7 of laundry dryer 1 is configured/programmed to switch on and off the cooling fan 20, so as to maintain the average temperature of the refrigerant at refrigerant-outlet of the evaporator 13, i.e. of the air/refrigerant heat exchanger 13, within a given narrow temperature range encompassing/including the calculated refrigerant saturation temperature. The upper and lower ends of this narrow temperature range are conveniently selected so that the average “thermodynamic quality ratio” TQ of the low-pressure refrigerant coming out of evaporator 13 is encompassed between 0.7 and 1.2.

In the example shown, in particular, central control unit 7 is configured/programmed to switch the cooling fan 20 on and off, or to vary the revolving speed of cooling fan 20, so as to maintain the average “thermodynamic quality ratio” TQ of the low-pressure refrigerant coming out of evaporator 13 within a predetermined operative range which is preferably, though not necessarily, encompassed between 0.7 and 1.15; or is preferably, though not necessarily, encompassed between 0.7 and 1.07; or is even preferably, though not necessarily, encompassed between 0.7 and 1.03.

In other words, in the example shown, the temperature of the refrigerant at refrigerant-outlet of evaporator 13 is preferably, though not necessarily, maintained from 3° C. below the calculated refrigerant saturation temperature to 6° C. above the calculated refrigerant saturation temperature. This implies that the difference between the measured refrigerant temperature at refrigerant-outlet of heat exchanger 13 and the calculated refrigerant saturation temperature is preferably, though not necessarily, maintained within an acceptable temperature range spanning between −3° C. and +6° C.

In view of the above, central control unit 7 of laundry dryer 1 is preferably, though not necessarily, configured/programmed
to increase the “thermodynamic quality ratio” TQ of the refrigerant at refrigerant-outlet of heat exchanger 13, when the difference between the measured refrigerant temperature and the calculated refrigerant saturation temperature goes below the lower limit of the acceptable temperature range (in the example shown −3° C.); and
to reduce the “thermodynamic quality ratio” TQ of the refrigerant at refrigerant-outlet of heat exchanger 13, when the difference between the measured refrigerant temperature and the calculated refrigerant saturation temperature rises above the upper limit of said acceptable temperature range (in the example shown 6° C.).

Clearly this active control of the “thermodynamic quality ratio” TQ of the refrigerant at refrigerant-outlet of evaporator 13, i.e. of heat exchanger 13, is preferably performed when hot-air generator 5 is in the steady-state working phase.

In other words, taking into consideration that activation of cooling fan 20 reduces the “thermodynamic quality ratio” TQ of the refrigerant at refrigerant-outlet of evaporator 13 and that deactivation of cooling fan 20 increases the “thermodynamic quality ratio” TQ of the refrigerant at refrigerant-outlet of evaporator 13, central control unit 7 of laundry dyer 1 deactivates the cooling fan 20 for increasing the “thermodynamic quality ratio” TQ of the refrigerant at refrigerant-outlet of evaporator 13, whenever the refrigerant temperature at refrigerant-outlet of the evaporator 13 goes below a predetermined first threshold value; and activates the cooling fan 20 for reducing the “thermodynamic quality ratio” TQ of the refrigerant at refrigerant-outlet of the evaporator 13, whenever the refrigerant temperature at refrigerant-outlet of heat evaporator 13 rises above a predetermined second threshold value which is higher than said first threshold value.

In the example shown, in particular, the first threshold value is 3° C. below the calculated refrigerant saturation temperature, and the second threshold value is 6° C. above the calculated refrigerant saturation temperature.

Obviously, the first and the second threshold value are conveniently selected to assure that the average “thermodynamic quality ratio” TQ of the refrigerant coming out of heat exchanger 13 remains encompassed between 0.7 and 1.2; or preferably between 0.7 and 1.15; or preferably between 0.7 and 1.07; or preferably between 0.7 and 1.03. Alternatively, the first and the second threshold value could be conveniently selected so as to maintain the average “thermodynamic quality ratio” TQ encompassed between 1 and 1.15, or between 1 and 1.07, or even between 1 and 1.03.

In other words, when hot-air generator 5 is in the steady-state working phase, central control unit 7 deactivates the cooling fan 20 for increasing the current “thermodynamic quality ratio” TQ of the refrigerant at refrigerant-outlet of the evaporator 13, whenever the refrigerant temperature at refrigerant-outlet of evaporator 13 goes too far below the corresponding calculated refrigerant saturation temperature; and activates the cooling fan 20 for reducing the current “thermodynamic quality ratio” TQ of the refrigerant at refrigerant-outlet of the evaporator 13, whenever the refrigerant temperature at refrigerant-outlet of evaporator 13 goes too far above the corresponding refrigerant saturation temperature.

Instead, if the refrigerant temperature measured at refrigerant-outlet of the evaporator 13 is significantly greater than the calculated refrigerant saturation temperature (i.e. an intensive refrigerant superheating is taking place in the evaporator 13), central control unit 7 of laundry dryer 1 activates the cooling fan 20 to maximize the cooling of the refrigerant flowing through heat exchanger 19 for reducing the “thermodynamic quality ratio” TQ of the refrigerant at refrigerant-outlet of the evaporator 13. This intensive cooling down of the refrigerant is however performed only if the hot-air generator 5 is in the steady-state working phase.

It is clear that a variable-speed cooling fan 20 allows a much more accurate control of the “thermodynamic quality ratio” TQ of the refrigerant at refrigerant-outlet of evaporator 13, i.e. at refrigerant-outlet of air/refrigerant heat exchanger 13.

To perform the control-strategy referred above, the laundry dryer 1 is provided with at least one pressure sensor (not shown) and with at least one temperature sensor (not shown), both located at refrigerant-outlet of evaporator 13 (i.e. at refrigerant-outlet of the air/refrigerant heat exchanger 13), for continuously measuring the refrigerant local pressure and temperature.

Taking into consideration that refrigerant pressure at outlet of evaporator 13 is substantially equal to the refrigerant pressure at suction of refrigerant compressing device 15 or at low-pressure refrigerant outlet of internal heat exchanger 18, the pressure sensor could also be located at low-pressure refrigerant outlet of internal heat exchanger 18 or at suction of refrigerant compressing device 15.

According to an alternative control strategy valid both for pure refrigerant and refrigerant blends, central control unit 7 of laundry dryer 1 can maintain between 0.7 and 1.2 the “thermodynamic quality ratio” TQ of the refrigerant at refrigerant-outlet of evaporator 13, via a selected activation and deactivation of cooling fan 20 on the basis of the current pressure and temperature of the refrigerant measured at low-pressure refrigerant outlet of refrigerant/refrigerant heat exchanger 18.

The measurement of the current pressure of the refrigerant at low-pressure refrigerant outlet of internal heat exchanger 18 may be replaced by the measurement of the current pressure of the refrigerant at refrigerant-outlet of evaporator 13 because substantially no pressure drops occurs while the refrigerant flows along the low pressure side of internal heat exchanger 18, or by the measurement of the current pressure of the refrigerant at suction of refrigerant compressing device 15.

As stated before, the refrigerant saturation temperature is a scalar physical quantity which depends strictly on the type of refrigerant and on its pressure, therefore central control unit 7 firstly measures the current pressure of the refrigerant at low-pressure refrigerant outlet of internal heat exchanger 18, or at suction of refrigerant compressing device 15, or at refrigerant-outlet of heat exchanger 13; then calculates the exact refrigerant saturation temperature on the basis of the measured current refrigerant pressure; and finally compares the refrigerant temperature measured at low-pressure refrigerant outlet of heat exchanger 18 with the calculated refrigerant saturation temperature, so as to determine whether the refrigerant coming out of the low-pressure refrigerant outlet of internal heat exchanger 18 is superheated and the current amount of such superheating.

If the difference between the refrigerant temperature measured at low-pressure refrigerant outlet of heat exchanger 18 and the calculated refrigerant saturation temperature is very high (for example greater than 18° C.), it means that the low-pressure refrigerant is deeply superheated and that, therefore, the low-pressure refrigerant comes out of evaporator 13 when refrigerant evaporation is already finalized. Thus the refrigerant temperature at refrigerant-outlet of evaporator 13 has to be greater than the corresponding refrigerant saturation temperature, and the “thermodynamic quality ratio” TQ of the refrigerant at refrigerant-outlet of evaporator 13 has to be greater than 1.

Instead, if the difference between the refrigerant temperature measured at low-pressure refrigerant outlet of heat exchanger 18 and the calculated refrigerant saturation temperature is very low (for example lower than 3° C.), it means that the low-pressure refrigerant is only slightly superheated and that, therefore, the low-pressure refrigerant comes out of the evaporator 13 still partly in liquid state. As a consequence the refrigerant temperature at refrigerant-outlet of evaporator 13 has to be lower than the corresponding refrigerant saturation temperature, and the “thermodynamic quality ratio” TQ of the refrigerant at refrigerant-outlet of evaporator 13 has to be lower than 1.

Assuming that the current temperature of the refrigerant at low-pressure refrigerant outlet of internal heat exchanger 18 has always to be greater than the calculated refrigerant saturation temperature (the refrigerant reaching the suction of refrigerant compressing device 15 has to be at least a little bit superheated), central control unit 7 of laundry dryer 1 is configured/programmed to switch the cooling fan 20 on and off, so as to keep the difference between the current temperature of the refrigerant at low-pressure refrigerant outlet of internal heat exchanger 18 and the calculated refrigerant saturation temperature, i.e. the current refrigerant superheating, within a predetermined temperature range which is located above the calculated refrigerant saturation temperature and which depends on the structure of internal heat exchanger 18.

Obviously the upper and lower ends of this temperature range are conveniently selected so that the average “thermodynamic quality ratio” TQ of the low-pressure refrigerant coming out of evaporator 13 is encompassed between 0.7 and 1.2.

In particular, central control unit 7 is preferably, configured/programmed to switch the cooling fan 20 on and off, or to vary the revolving speed of cooling fan 20, so as to maintain the average “thermodynamic quality ratio” TQ of the low-pressure refrigerant coming out of evaporator 13 within a predetermined operative range which is preferably, though not necessarily, encompassed between 0.7 and 1.15; or is preferably, though not necessarily, encompassed between 0.7 and 1.07; or is even preferably, though not necessarily, encompassed between 0.7 and 1.03. As an alternative, the operative range for the average “thermodynamic quality ratio” TQ could be encompassed between 1 and 1.15, or between 1 and 1.07, or even between 1 and 1.03.

In this second embodiment, for example, the central control unit 7 of laundry dryer 1 is preferably, though not necessarily, configured/programmed to switch the cooling fan 20 on and off, so to maintain the average temperature the refrigerant at low-pressure refrigerant outlet of internal heat exchanger 18 from 3° C. to 20° C. above the calculated refrigerant saturation temperature. This implies that the difference between the current temperature of the refrigerant at low-pressure refrigerant outlet of internal heat exchanger 18 and the corresponding calculated refrigerant saturation temperature is preferably, though not necessarily, maintained within an acceptable temperature range spanning between 3° C. and 20° C.

In view of the above, central control unit 7 of laundry dryer 1 is preferably, though not necessarily, configured/programmed
to increase the “thermodynamic quality ratio” TQ of the refrigerant at refrigerant-outlet of evaporator 13, when the difference between the current temperature of the refrigerant at low-pressure refrigerant outlet of internal heat exchanger 18 and the calculated refrigerant saturation temperature goes below the lower limit of said acceptable temperature range (in the example shown 3° C.); and
to reduce the “thermodynamic quality ratio” TQ of the refrigerant at refrigerant-outlet of evaporator 13, when the difference between the current temperature of the refrigerant at low-pressure refrigerant outlet of internal heat exchanger 18 and the calculated refrigerant saturation temperature exceeds the upper limit of said acceptable temperature range (in the example shown 20° C.).

Again this active control of the “thermodynamic quality ratio” TQ of the refrigerant at refrigerant-outlet of evaporator 13 is preferably performed when hot-air generator 5 is in the steady-state working phase.

In other words, when hot-air generator 5 is in the steady-state working phase, the central control unit 7 of laundry dyer 1 deactivates the cooling fan 20 for increasing the current “thermodynamic quality ratio” TQ of the refrigerant at refrigerant-outlet of evaporator 13, whenever the refrigerant temperature at low-pressure refrigerant outlet of internal heat exchanger 18 goes below a predetermined first threshold value; and activates the cooling fan 20 for reducing the current “thermodynamic quality ratio” TQ of the refrigerant at refrigerant-outlet of evaporator 13, whenever the refrigerant temperature at low-pressure refrigerant outlet of refrigerant/refrigerant heat exchanger 18 exceeds a predetermined second threshold value which is greater than said first threshold value. In fact, activation of cooling fan 20 reduces the “thermodynamic quality ratio” TQ of the refrigerant at refrigerant-outlet of heat exchanger 13; whereas deactivation of cooling fan 20 increases the “thermodynamic quality ratio” TQ of the refrigerant at refrigerant-outlet of heat exchanger 13.

In the example shown, in particular, the first threshold value is 3° C. above the calculated refrigerant saturation temperature, and the second threshold value is 20° C. above the calculated refrigerant saturation temperature.

Obviously, the first and the second threshold value are conveniently selected to assure that the average “thermodynamic quality ratio” TQ of the refrigerant coming out of evaporator 13 remains encompassed between 0.7 and 1.2; or preferably between 0.7 and 1.15; or preferably between 0.7 and 1.07; or preferably between 0.7 and 1.03. Alternatively, the first and the second threshold value could be conveniently selected so as to maintain the average “thermodynamic quality ratio” TQ encompassed between 1 and 1.15, or between 1 and 1.07, or even between 1 and 1.03.

In other words, when hot-air generator 5 is in the steady-state working phase, central control unit 7 keeps the cooling fan 20 switched off for increasing the current “thermodynamic quality ratio” TQ of the refrigerant at refrigerant-outlet of evaporator 13, if the refrigerant temperature at low-pressure refrigerant outlet of internal heat exchanger 18 decreases/arrives too close to the corresponding refrigerant saturation temperature; and keeps the cooling fan 20 switched on for reducing the current “thermodynamic quality ratio” TQ of the refrigerant at refrigerant-outlet of evaporator 13, if the refrigerant temperature at low-pressure refrigerant outlet of internal heat exchanger 18 goes too much high with respect to the corresponding calculated refrigerant saturation temperature.

Also in this case, it is clear that a variable-speed cooling fan 20 allows a much more accurate control of the “thermodynamic quality ratio” TQ of the refrigerant at refrigerant-outlet of heat exchanger 13, i.e. of evaporator 13.

To perform the control-strategy referred above, the laundry dryer 1 is provided with at least one pressure sensor (not shown) and with at least one temperature sensor (not shown), both located at low-pressure refrigerant outlet of internal heat exchanger 18 for continuously measuring the refrigerant local pressure and temperature.

Taking into consideration that refrigerant pressure at low-pressure refrigerant outlet of internal heat exchanger 18 is substantially equal to the refrigerant pressure at suction of refrigerant compressing device 15 or at outlet of evaporator 13, the pressure sensor could also be located at outlet of evaporator 13 or at suction of refrigerant compressing device 15.

According to a different thermodynamic approach, as previously explained the “thermodynamic quality ratio” TQ of the refrigerant at refrigerant-outlet of evaporator 13 is lower than 1 when the refrigerant temperature at refrigerant-outlet of evaporator 13 goes below the refrigerant saturation temperature at the same refrigerant pressure, and it is greater than 1 when the refrigerant temperature at refrigerant-outlet of evaporator 13 rises above the refrigerant saturation temperature at the same refrigerant pressure.

Thus, considering refrigerant zeotropic blends, in the first case the refrigerant coming out of the refrigerant-outlet of evaporator 13 is at least partially in liquid state, and has been subjected to a “negative” superheating while flowing through the evaporator 13. In the second case, instead, the refrigerant coming out of the refrigerant-outlet of evaporator 13 is completely vaporized, i.e. in gaseous state, and has been subjected to a “positive” superheating while flowing through the evaporator 13.

In view of the above, central control unit 7 can check whether the current “thermodynamic quality ratio” TQ of the refrigerant at refrigerant-outlet of evaporator 13 goes below 1 or above 1, via a direct measurement and comparison between the temperature drop of the refrigerant flowing in the high-pressure side of internal heat exchanger 18, and the temperature rise of the refrigerant flowing in the low-pressure side of the same internal heat exchanger 18.

If the low-pressure refrigerant at refrigerant-outlet of evaporator 13 is completely in gaseous state, the refrigerant flowing in the low-pressure side of heat exchanger 18 is merely superheated, and the increase of the refrigerant temperature measured at the low-pressure side of heat exchanger 18 is significantly higher than the drop of refrigerant temperature measured at the high-pressure side of heat exchanger 18. This is due to the fact that a refrigerant almost completely in liquid state (i.e. the refrigerant flowing in the high-pressure side of heat exchanger 18) has a thermal capacity, i.e. a specific heat, considerably higher than that of a whole gaseous-state refrigerant (i.e. the refrigerant flowing in the low-pressure side of heat exchanger 18).

Instead, if the refrigerant at refrigerant-outlet of evaporator 13 is still partly in liquid state, the refrigerant flowing in the low-pressure side of heat exchanger 18 has to be firstly completely vaporized and then superheated, thus the difference between the increase of the refrigerant temperature measured at the low-pressure side of heat exchanger 18 and the drop of the refrigerant temperature measured at the high-pressure side of heat exchanger 18 is small. This is due to the fact that the average thermal capacity of the refrigerant flowing in the low-pressure side of heat exchanger 18 becomes close to the thermal capacity of the liquid-state refrigerant flowing in the high-pressure side of heat exchanger 18.

Thus, central control unit 7 of laundry dryer 1 may be configured/programmed
to reduce the “thermodynamic quality ratio” TQ of the refrigerant at refrigerant-outlet of evaporator 13, when the temperature rise of the refrigerant in the low-pressure side of heat exchanger 18 exceeds of a predetermined first tolerance value the temperature drop of the refrigerant at high-pressure side of heat exchanger 18 (for example the temperature rise of the low-pressure refrigerant exceeds the temperature drop of the high-pressure refrigerant of more that 25° C.); and
to increase the “thermodynamic quality ratio” TQ of the refrigerant at refrigerant-outlet of evaporator 13, when the temperature drop of the refrigerant at high-pressure side of heat exchanger 18 exceeds the temperature rise of the refrigerant in the low-pressure side of heat exchanger 18 of a predetermined second tolerance value (for example the temperature drop of the high-pressure refrigerant exceeds the temperature rise of the low-pressure refrigerant of more that 3° C.).

Additionally, the central control unit 7 of laundry dryer 1 may be configured/programmed
to increase the “thermodynamic quality ratio” TQ of the refrigerant at refrigerant-outlet of evaporator 13, when the temperature rise of the refrigerant at low-pressure side of heat exchanger 18 goes below a third tolerance value greater that 0° C. (for example this third tolerance value is equal to 5° C.), so as to ensure that refrigerant at suction of refrigerant compressing device 15 is always a little bit superheated to ensure optimal working of refrigerant compressing device 15.

Obviously, the first tolerance value is significantly greater than 0° C. (for example 25° C.), whereas the second tolerance value is preferably, though not necessarily, lower than the first tolerance value.

In other words, when hot-air generator 5 is in the steady-state working phase, central control unit 7 of laundry dryer 1 activates the cooling fan 20 for reducing the current “thermodynamic quality ratio” TQ of the refrigerant at refrigerant-outlet of evaporator 13, if the temperature rise of the refrigerant flowing in the low-pressure side of heat exchanger 18 exceeds of a predetermined first tolerance value the temperature drop of the refrigerant flowing in the high-pressure side of heat exchanger 18 (for example the temperature rise of the low-pressure refrigerant is more than 25° C. higher than the temperature drop of the high-pressure refrigerant). Moreover central control unit 7 of laundry dryer 1 deactivates the cooling fan 20 for increasing the current “thermodynamic quality ratio” TQ of the refrigerant at refrigerant-outlet of evaporator 13, if the temperature drop of the refrigerant flowing in the high-pressure side of heat exchanger 18 exceeds of a predetermined second tolerance value the temperature rise of the refrigerant flowing in the low-pressure side of heat exchanger 18 (for example the temperature drop of the high-pressure refrigerant is more than 3° C. higher than the temperature rise of the low-pressure refrigerant); or if the temperature rise of the refrigerant flowing in the low-pressure side of heat exchanger 18 goes below a predetermined third threshold value (for example it goes below 5° C.).

Thus central control unit 7 of laundry dryer 1 is preferably, though not necessarily, configured/programmed to measure the temperature drop of the refrigerant flowing in the high-pressure side of internal heat exchanger 18, and the temperature rise of the refrigerant flowing in the low-pressure side of internal heat exchanger 18; and to drive the refrigerant cooling device 17, i.e. the refrigerant thermodynamic-parameters adjusting means, so as to keep the difference between the temperature rise of the refrigerant flowing in the low-pressure side of heat exchanger 18 and the temperature drop of the refrigerant flowing in the high-pressure side of heat exchanger 18, within a predetermined tolerance range whose upper and lower ends are conveniently selected so that the “thermodynamic quality ratio” TQ of the refrigerant coming out of evaporator 13 remains encompassed between 0.7 and 1.2.

The upper and lower ends of this tolerance range are conveniently selected so that the average “thermodynamic quality ratio” TQ of the refrigerant coming out of heat exchanger 13 remains encompassed preferably, though not necessarily, between 0.7 and 1.15, or between 0.7 and 1.07, or even between 0.7 and 1.03. Alternatively, the upper and lower ends of this tolerance range could be conveniently selected so as to maintain the average “thermodynamic quality ratio” TQ encompassed between 1 and 1.15, or between 1 and 1.07, or even between 1 and 1.03.

In this third embodiment, in particular, central control unit 7 is configured/programmed to switch the cooling fan 20 on and off, so as to keep the difference between the temperature rise of the refrigerant flowing in the low-pressure side of heat exchanger 18 and the temperature drop of the refrigerant flowing in the high-pressure side of heat exchanger 18, within a tolerance range preferably, though not necessarily, extending from −3° C. to 25° C.

In other words, when hot-air generator 5 is in the steady-state working phase, central control unit 7 of laundry dryer 1 activates the cooling fan 20 for reducing the current “thermodynamic quality ratio” TQ of the refrigerant at refrigerant-outlet of evaporator 13, whenever the difference between the temperature rise of the refrigerant flowing in the low-pressure side of heat exchanger 18 and the temperature drop of the refrigerant flowing in the high-pressure side of heat exchanger 18 exceeds the upper limit of said tolerance range (for example the upper limit is equal to 25° C.). Instead central control unit 7 deactivates the cooling fan 20 for increasing the “thermodynamic quality ratio” TQ of the refrigerant at refrigerant-outlet of evaporator 13, whenever the difference between the temperature rise of the refrigerant flowing in the low-pressure side of heat exchanger 18 and the temperature drop of the refrigerant flowing in the high-pressure side of heat exchanger 18 goes below the lower limit of said tolerance (for example the lower limit is equal to −3° C.); or whenever the temperature rise of the refrigerant flowing in the low-pressure side of heat exchanger 18 goes below a predetermined threshold value (for example it goes below 5° C.).

Obviously, this threshold value is greater than zero so as to ensure that the low-pressure and low-temperature refrigerant flowing in the low-pressure side of internal heat exchanger 18 is at least a little bit superheated before reaching the suction of refrigerant compressing device 15.

To perform this third control-strategy, the laundry dryer 1 is provided with four temperature sensors (not shown), each located at a respective inlet or outlet of heat exchanger 18 to measure the corresponding refrigerant temperatures.

In a fourth embodiment, central control unit 7 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature difference of the refrigerant flowing in the evaporator 13, i.e. in the air/refrigerant heat exchanger 13.

In fact, in theory the complete liquid-to-gaseous phase-change of a pure/ideal fluid takes place at a constant temperature. This implies that, if the refrigerant is partly in liquid state when coming out of refrigerant 13, the temperature drop of the refrigerant flowing through the evaporator 13 should be zero, because the refrigerant liquid-to-gaseous phase-change is not finalized at refrigerant-outlet of evaporator 13.

In reality, a slight pressure drop occurs while the refrigerant flows through the evaporator 13, thus a temperature drop slightly greater than 0° C. is normally measured even if the refrigerant coming out of heat exchanger 13 is still partly in liquid state. On the contrary, if refrigerant superheating takes place inside evaporator 13, there is a significant increase in the refrigerant temperature at refrigerant-outlet of evaporator 13.

In view of the above, central control unit 7 of laundry dryer 1 can measure the temperature drop of the refrigerant flowing in evaporator 13 and, when the hot-air generator is in the steady-state working phase, it can continuously switch the cooling fan 20 on and off so as to keep the temperature drop of the refrigerant flowing through the evaporator 13 as constant as possible within a given narrow temperature range.

Obviously, the upper and lower ends of this narrow temperature range are conveniently selected so that the “thermodynamic quality ratio” TQ of the refrigerant coming out of heat exchanger 13 is encompassed between 0.7 and 1.2.

More specifically, the upper and lower ends of this narrow temperature range are conveniently selected so that the average “thermodynamic quality ratio” TQ of the refrigerant coming out of evaporator 13 is preferably, though not necessarily, encompassed between 0.7 and 1.15, or between 0.7 and 1.07, or even between 0.7 and 1.03. As an alternative, the average “thermodynamic quality ratio” TQ could be encompassed between 1 and 1.15, or between 1 and 1.07, or even between 1 and 1.03.

In the example shown, in particular, central control unit 7 is configured/programmed to continuously switch the cooling fan 20 on and off, so as to keep either the temperature rise of the refrigerant flowing through the evaporator 13 within a given narrow temperature range extending from approximately 0° C. to 15° C., and preferably, though not necessarily, extending from 0° C. to 10° C. and preferably, though not necessarily, extending from 0° C. to 5° C.; or the temperature drop of the refrigerant flowing through the evaporator 13 within a given narrow temperature range extending from approximately 0° C. to 10° C., and preferably, though not necessarily, extending from 0.2° C. to 5° C.

In other words, central control unit 7 is configured/programmed to continuously switch the cooling fan 20 on and off so as to keep the temperature difference of the refrigerant flowing through the evaporator 13 within a given temperature range extending approximately from +15° C. to −10° C., or even preferably, though not necessarily, from +10° C. to −5° C. or +5° C. to −5° C.

Thus, central control unit 7 of laundry dryer 1 is preferably, though not necessarily, configured/programmed
to increase the “thermodynamic quality ratio” TQ of the refrigerant at refrigerant-outlet of evaporator 13, when the temperature difference (temperature drop) of the refrigerant flowing through evaporator 13 goes below the lower limit of said temperature range (for example when it goes below 0.2° C.); and
to reduce the “thermodynamic quality ratio” TQ of the refrigerant at refrigerant-outlet of evaporator 13, when the temperature difference (temperature rise) of the refrigerant flowing through evaporator 13 exceeds the upper limit of said temperature range (for example when it exceeds the 15° C.).

In other words, when hot-air generator 5 is in the steady-state working phase, central control unit 7 of laundry dryer 1 activates the cooling fan 20 for reducing the current “thermodynamic quality ratio” TQ of the refrigerant at refrigerant-outlet of heat exchanger 13, whenever the temperature rise of the refrigerant flowing through the evaporator 13 exceeds a first threshold value (for example 15° C.); and deactivates the cooling fan 20 for increasing the current “thermodynamic quality ratio” TQ of the refrigerant at refrigerant-outlet of evaporator 13, whenever the temperature drop of the refrigerant flowing through the evaporator 13 goes below a second threshold value (for example 5° C.). The activation of cooling fan 20, in fact, reduces the “thermodynamic quality ratio” TQ of the refrigerant at refrigerant-outlet of evaporator 13, whereas the deactivation of cooling fan 20 increases the “thermodynamic quality ratio” TQ of the refrigerant at refrigerant-outlet of evaporator 13.

To perform this fourth control-strategy, the laundry dryer 1 is provided with two temperature sensors located, respectively, at refrigerant-inlet and at refrigerant-outlet of evaporator 13 to measure the corresponding refrigerant temperatures.

Optionally, central control unit 7 may improve precision of the fourth control-strategy referred above via an additional control of the temperature drop of the refrigerant that flows in the high-pressure side of internal heat exchanger 18. If the temperature drop of the refrigerant flowing through the evaporator 13 is slightly greater than 0° C. and, at the same time, the temperature drop of the refrigerant flowing in the high-pressure side of refrigerant/refrigerant heat exchanger 18 is significantly high, this means that internal heat exchanger 18 is finalizing the evaporation of the low-pressure refrigerant.

This combined control-strategy is particularly helpful when the behavior of the refrigerant flowing in the heat-pump assembly 11 is that of a pure/ideal fluid.

In other words, in a fifth embodiment the central control unit 7 of laundry dryer 1 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature drop/rise of the refrigerant flowing in the evaporator 13, i.e. flowing in the air/refrigerant heat exchanger 13, and of the temperature drop of the refrigerant flowing through the high-pressure side of internal heat exchanger 18.

In fact, as stated in the previous embodiment, for pure fluids the temperature drop of the refrigerant flowing through the evaporator 13 is very close to zero when the refrigerant coming out from evaporator 13 is partly in liquid state, because the refrigerant liquid-to-gaseous phase-change takes place at a constant temperature and this phase-change is not finalized at refrigerant-outlet of heat exchanger 13.

Instead, the drop of the refrigerant temperature at the high-pressure side of internal heat exchanger 18 is considerably high when the refrigerant coming out from evaporator 13 is partly in liquid state, because the high-temperature and high-pressure refrigerant flowing through internal heat exchanger 18 has to transfer to the low-pressure refrigerant flowing through the same heat exchanger enough heat to finalize both the evaporation and the superheating. The latent evaporation heat transfer coefficient of the refrigerant, in fact, is considerably higher than the sensible heat transfer coefficient of the same refrigerant.

In view of the above, the central control unit 7 of laundry dryer 1 is configured/programmed to measure both the temperature drop/rise of the refrigerant flowing in evaporator 13, and the temperature drop of the refrigerant that flows in the high-pressure side of internal heat exchanger 18; and to continuously switch, when the hot-air generator is in the steady-state working phase, the cooling fan 20 on and off
so as to keep the temperature drop/rise of the refrigerant flowing through the evaporator 13 within a first temperature range, and, at the same time,
so as to keep the temperature drop of the refrigerant flowing through the high-pressure side of internal heat exchanger 18 within a second temperature range whose upper and lower ends are both significantly higher than 0° C.

Preferably, in the example shown, the first temperature range extends preferably, though not necessarily, from +15° C. to −10° C., or preferably, though not necessarily, from +10° C. to −5° C.; whereas the second temperature range extends preferably, though not necessarily, from 10° C. to 25° C., thus assuring that the complete vaporization of the refrigerant and subsequent superheating of the refrigerant take place inside internal heat exchanger 18 or giving an extra superheating to the refrigerant coming from the evaporator 13.

Central control unit 7 is therefore preferably, though not necessarily, configured/programmed
to reduce the “thermodynamic quality ratio” TQ of the refrigerant at refrigerant-outlet of evaporator 13 when the temperature difference (temperature rise) of the refrigerant flowing through evaporator 13 exceeds the upper limit of said temperature range (for example when it exceeds the 15° C.), and when, at the same time, the temperature drop of the refrigerant flowing through the high-pressure side of internal heat exchanger 18 goes below the lower limit of said second temperature range (for example 5° C.); and
to increase the “thermodynamic quality ratio” TQ of the refrigerant at refrigerant-outlet of evaporator 13, when the temperature difference (temperature drop) of the refrigerant flowing through evaporator 13 goes below the lower limit of said temperature range (for example when it goes below 0.2° C.), and when, at the same time, the temperature drop of the refrigerant flowing the high-pressure side of internal heat exchanger 18 exceeds the upper limit of the second temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the temperature rise of the refrigerant flowing through the evaporator 13 exceeds a first threshold value (for example 15° C.), and whenever, at the same time, the temperature drop of the refrigerant flowing through the high-pressure side of internal heat exchanger 18 goes below a second threshold value (for example 5° C.); and deactivates the cooling fan 20 for increasing the “vapor quality” of the refrigerant at refrigerant-outlet of heat exchanger 13, whenever the temperature drop of the refrigerant flowing through the evaporator 13 goes below a third threshold value (for example −10° C.) which is lower than said first threshold value, and whenever, at the same time, the temperature drop of the refrigerant flowing through the high-pressure side of internal heat exchanger 18 exceeds a fourth threshold value (for example 25° C.) which is higher than said second threshold value.

In fact activation of cooling fan 20 reduces the “thermodynamic quality ratio” TQ of the refrigerant at refrigerant-outlet of the evaporator 13; whereas deactivation of cooling fan 20 increases the “thermodynamic quality ratio” TQ of the refrigerant at refrigerant-outlet of the evaporator 13.

In the first case, a complete evaporation and high superheating of the refrigerant is taking place inside the evaporator 13, i.e. inside the air/refrigerant heat exchanger 13, and heat exchanger 18 is merely finalizing the superheating of the refrigerant. In the second case, the liquid state portion of the refrigerant coming out from evaporator 13 is excessive, and the internal heat exchanger 18 is not able to finalize the evaporation of low-pressure refrigerant and afterwards superheating the refrigerant directed towards the suction of refrigerant compressing device 15.

To perform this fifth control-strategy, the laundry dryer 1 is provided with four temperature sensors located, respectively, at refrigerant-inlet of evaporator 13, at refrigerant-outlet of evaporator 13, at high-pressure refrigerant inlet of heat exchanger 18 and finally at high-pressure refrigerant outlet of heat exchanger 18 to measure the corresponding refrigerant temperatures.

In a sixth embodiment, central control unit 7 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature drop/rise of the refrigerant flowing in the evaporator 13 (i.e. flowing in heat exchanger 13), and of the temperature rise of the refrigerant flowing in the low-pressure side of internal heat exchanger 18.

Similarly to the previous embodiment, this combined control-strategy is particularly helpful when the behavior of the refrigerant flowing in the heat-pump assembly 11 is that of a pure/ideal fluid.

As stated above, the temperature drop of the refrigerant flowing through the evaporator 13 is very close to zero when the refrigerant coming out of evaporator 13 is partly in liquid state, because the refrigerant liquid-to-gaseous phase-change takes place at a constant temperature and it is not finalized at refrigerant-outlet of heat exchanger 13.

Instead, when the refrigerant coming out of evaporator 13 is not partly in liquid state, the temperature rise of the refrigerant flowing through the low-pressure side of internal heat exchanger 18 is significantly high, i.e. significantly greater than zero, because the refrigerant flowing in the low-pressure side of internal heat exchanger 18 is to be only superheated.

In view of the above, central control unit 7 of laundry dryer 1 can measure both the temperature rise/drop of the refrigerant flowing in the evaporator 13, and the temperature rise of the refrigerant flowing in the low-pressure side of internal heat exchanger 18; and, when hot-air generator is in the steady-state working phase, it can switch the cooling fan 20 on and off (i.e. adjust the “thermodynamic quality ratio” TQ of the refrigerant at refrigerant-outlet of evaporator 13), so as to keep the temperature rise/drop of the refrigerant flowing through the evaporator 13 as constant as possible within a first narrow temperature range preferably, though not necessarily, extending from +15° C. to −10° C., and, at the same time, so as to keep the temperature rise of the refrigerant flowing through the low-pressure side of heat exchanger 18 within a second broader temperature range which is always above than the first temperature range, and which preferably, though not necessarily, extends from 3° C. to 25° C.

Thus, central control unit 7 is preferably, though not necessarily, configured/programmed
to reduce the “thermodynamic quality ratio” TQ of the refrigerant at refrigerant-outlet of heat exchanger 13, when the temperature difference (temperature rise) of the refrigerant flowing through evaporator 13 exceeds the upper limit of said first temperature range (for example 15° C.), and when, at the same time, the temperature rise of the refrigerant flowing through the low-pressure side of heat exchanger 18 exceeds the upper limit of said second temperature range (for example 25° C.); and
to increase the “thermodynamic quality ratio” TQ of the refrigerant at refrigerant-outlet of heat exchanger 13, when the temperature difference (temperature drop) of the refrigerant flowing through evaporator 13 goes below the lower limit of the first temperature range (for example 0.2° C.), and when, at the same time, the temperature rise of the refrigerant flowing through the low-pressure side of heat exchanger 18 goes below the lower limit of said second threshold value (for example 3° C.).

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the temperature rise of the refrigerant flowing through the evaporator 13 exceeds a first threshold value (for example 15° C.), and whenever the temperature rise of the refrigerant flowing through the low-pressure side of internal heat exchanger 18 exceeds a second threshold value (for example 25° C.); and deactivates the cooling fan 20 for increasing the “thermodynamic quality ratio” TQ of the refrigerant at refrigerant-outlet of heat exchanger 13, whenever the temperature drop of the refrigerant flowing through the evaporator 13 goes below a third threshold value (for example −10° C.) which is lower than said first threshold value, and the temperature rise of the refrigerant flowing through the low-pressure side of internal heat exchanger 18 goes below a fourth threshold value (for example 3° C.) which is lower than said second threshold value. Activation of cooling fan 20, in fact, reduces the “thermodynamic quality ratio” TQ of the refrigerant at refrigerant-outlet of heat exchanger 13; whereas deactivation of cooling fan 20 increases the “thermodynamic quality ratio” TQ of the refrigerant at refrigerant-outlet of heat exchanger 13.

The fourth threshold value is always greater than the second threshold value.

In the first case, a complete evaporation of the refrigerant is taking place inside the evaporator 13, i.e. inside the air/refrigerant heat exchanger 13, and the heat exchanger 18 only finalizes the superheating of the refrigerant. In the second case, the liquid state portion of the refrigerant coming out from the evaporator 13 is excessive, and the internal heat exchanger 18 is not able to finalize the evaporation of low-pressure refrigerant and afterwards superheat the refrigerant directed towards the suction of refrigerant compressing device 15.

To perform this sixth control-strategy, the laundry dryer 1 is provided with three temperature sensors located, respectively, at refrigerant-inlet of the evaporator 13, at refrigerant-outlet of the evaporator 13, and finally at low-pressure refrigerant outlet of heat exchanger 18 to measure the corresponding refrigerant temperatures. The refrigerant temperature at low-pressure refrigerant inlet of heat exchanger 18, in fact, is to be considered equal to the refrigerant temperature at refrigerant-outlet of heat exchanger 13.

The above mentioned control-strategy can be also adapted to deal with refrigerant zeotropic blends, taking into consideration that the complete liquid-to-gaseous phase-change of a refrigerant zeotropic blend takes place at increasing temperature. This implies that the refrigerant flowing through the evaporator 13 is subjected to a temperature rise greater than zero, even if the liquid-to-gaseous phase-change is not finalized at refrigerant-outlet of evaporator 13.

In view of the above, assuming that the refrigerant coming out of evaporator 13 is partly in liquid state, central control unit 7 of laundry dryer 1 can measure the temperature rise of the refrigerant flowing in evaporator 13 and, when the hot-air generator is in the steady-state working phase, it can continuously switch the cooling fan 20 on and off so as to keep the temperature rise of the refrigerant flowing through the evaporator 13 as constant as possible within a given narrow temperature range.

Obviously, the upper and lower ends of this narrow temperature range are conveniently selected so that the average “thermodynamic quality ratio” TQ of the refrigerant coming out of evaporator 13 is encompassed between 0.7 and 1.2, and in particular it is preferably, though not necessarily, encompassed between 0.7 and 1.15, or between 0.7 and 1.07, or even between 0.7 and 1.03.

Alternatively, the upper and lower ends of this narrow temperature range could be conveniently selected so as to maintain the average “thermodynamic quality ratio” TQ encompassed between 1 and 1.15, or between 1 and 1.07, or even between 1 and 1.03.

In the example shown, in particular, central control unit 7 is configured/programmed to continuously switch the cooling fan 20 on and off, so as to keep the temperature rise of the refrigerant flowing through the evaporator 13 within a given narrow temperature range extending from approximately 1° C. to 20° C., or even from 0° C. to 15° C., and preferably, though not necessarily, extending from 2° C. to 7° C.

Thus, central control unit 7 of laundry dryer 1 is preferably, though not necessarily, configured/programmed
to increase the “thermodynamic quality ratio” TQ of the refrigerant at refrigerant-outlet of evaporator 13, when the temperature rise of the refrigerant flowing through evaporator 13 goes below the lower limit of said temperature range (for example when it goes below 2° C.); and
to reduce the “thermodynamic quality ratio” TQ of the refrigerant at refrigerant-outlet of evaporator 13, when the temperature rise of the refrigerant flowing through evaporator 13 exceeds the upper limit of said temperature range (for example when it exceeds 7° C.).

In other words, taking into consideration that activation of cooling fan 20 reduces the “thermodynamic quality ratio” TQ of the refrigerant at refrigerant-outlet of evaporator 13 and that deactivation of cooling fan 20 increases the “thermodynamic quality ratio” TQ of the refrigerant at refrigerant-outlet of evaporator 13, central control unit 7 of laundry dryer 1 activates, when hot-air generator 5 is in the steady-state working phase, the cooling fan 20 for reducing the “thermodynamic quality ratio” TQ of the refrigerant at refrigerant-outlet of heat exchanger 13, whenever the temperature rise of the refrigerant flowing through the evaporator 13 exceeds a first threshold value (for example 7° C.). Additionally, central control unit 7 deactivates the cooling fan 20 for increasing the “thermodynamic quality ratio” TQ of the refrigerant at refrigerant-outlet of evaporator 13, whenever the temperature rise of the refrigerant flowing through the evaporator 13 goes below a second threshold value (for example 2° C.) which is lower than said upper threshold value.

To perform this control-strategy, the laundry dryer 1 is again provided with two temperature sensors located, respectively, at refrigerant-inlet and at refrigerant-outlet of evaporator 13 to measure the corresponding refrigerant temperatures.

Also in this case, central control unit 7 may optionally improve precision of this last control-strategy, via an additional control of the temperature drop of the refrigerant that flows in the high-pressure side of internal heat exchanger 18. If the temperature rise of the refrigerant flowing through the evaporator 13 is slightly greater than 0° C. and, at the same time, the temperature drop of the refrigerant flowing in the high-pressure side of refrigerant/refrigerant heat exchanger 18 is significantly high, this means that internal heat exchanger 18 is finalizing the evaporation of the low-pressure refrigerant and that, therefore, the refrigerant coming out of evaporator 13 is partly in liquid state.

In other words, in this embodiment the central control unit 7 of laundry dryer 1 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature rise of the refrigerant flowing through evaporator 13 (i.e. flowing through the air/refrigerant heat exchanger 13), and of the temperature drop of the refrigerant flowing through the high-pressure side of internal heat exchanger 18.

In fact, as stated above, the temperature rise of the refrigerant flowing through the evaporator 13 is slightly greater than zero when the refrigerant coming out of evaporator 13 is partly in liquid state.

Instead, the drop of the refrigerant temperature at the high-pressure side of internal heat exchanger 18 is considerably high when the refrigerant coming out of evaporator 13 is partly in liquid state, because the high-temperature and high-pressure refrigerant flowing through the internal heat exchanger 18 has to transfer to the low-pressure refrigerant flowing through the same heat exchanger enough heat to finalize both the evaporation and the superheating.

The latent evaporation heat transfer coefficient of the refrigerant, in fact, is considerably higher than the sensible heat transfer coefficient of the same refrigerant.

In view of the above, central control unit 7 of laundry dryer 1 can measure both the temperature rise of the refrigerant flowing in evaporator 13, and the temperature drop of the refrigerant that flows in the high-pressure side of internal heat exchanger 18; and, when the hot-air generator is in the steady-state working phase, it can continuously switch on and off the cooling fan 20, so as to keep the temperature rise of the refrigerant flowing through the evaporator 13 as constant as possible within a first narrow temperature range which extends preferably, though not necessarily, from 2° C. and 7° C., and, at the same time, so as to keep the temperature drop of the refrigerant flowing through the high-pressure side of internal heat exchanger 18 within a second temperature range whose upper and lower ends are both significantly higher than 0° C.

In the example shown, the first temperature range extends preferably, though not necessarily, from 2° C. to 8° C.; whereas the second temperature range extends preferably, though not necessarily, from 10° C. to 20° C., thus assuring that the complete vaporization of the refrigerant and subsequent superheating of the refrigerant take place inside internal heat exchanger 18.

Central control unit 7 is therefore preferably, though not necessarily, configured/programmed
to reduce the “thermodynamic quality ratio” TQ of the refrigerant at refrigerant-outlet of evaporator 13 when the temperature rise of the refrigerant flowing through the evaporator 13 exceeds the upper limit of said first temperature range (for example 8° C.), and when, at the same time, the temperature drop of the refrigerant flowing through the high-pressure side of internal heat exchanger 18 goes below the lower limit of said second temperature range (for example 10° C.); and
to increase the “thermodynamic quality ratio” TQ of the refrigerant at refrigerant-outlet of evaporator 13, when the temperature rise of the refrigerant flowing through the evaporator 13 goes below the lower limit of the first temperature range (for example 2° C.), and when, at the same time, the temperature drop of the refrigerant flowing the high-pressure side of internal heat exchanger 18 exceeds the upper limit of the second temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the temperature rise of the refrigerant flowing through the evaporator 13 exceeds a first threshold value (for example 8° C.), and whenever, at the same time, the temperature drop of the refrigerant flowing through the high-pressure side of internal heat exchanger 18 goes below a second threshold value (for example 10° C.); and deactivates the cooling fan 20 for increasing the “thermodynamic quality ratio” TQ of the refrigerant at refrigerant-outlet of heat exchanger 13, whenever the temperature rise of the refrigerant flowing through the evaporator 13 goes below a third threshold value (for example 2° C.) which is lower than said first threshold value, and whenever, at the same time, the temperature drop of the refrigerant flowing through the high-pressure side of internal heat exchanger 18 exceeds a fourth threshold value (for example 20° C.) which is higher than said second threshold value. Activation of cooling fan 20, in fact, reduces the “thermodynamic quality ratio” TQ of the refrigerant at refrigerant-outlet of the evaporator 13; whereas deactivation of cooling fan 20 increases the “thermodynamic quality ratio” TQ of the refrigerant at refrigerant-outlet of the evaporator 13.

In the first case, a complete evaporation of the refrigerant is taking place inside evaporator 13, i.e. inside the air/refrigerant heat exchanger 13, and heat exchanger 18 is merely finalizing the superheating of the refrigerant. In the second case, the liquid state portion of the refrigerant coming out from evaporator 13 is excessive, and the internal heat exchanger 18 is not able to finalize the evaporation of low-pressure refrigerant and afterwards superheating the refrigerant directed towards the suction of refrigerant compressing device 15.

To perform this improved control-strategy, the laundry dryer 1 is again provided with four temperature sensors located, respectively, at refrigerant-inlet of evaporator 13, at refrigerant-outlet of evaporator 13, at high-pressure refrigerant inlet of heat exchanger 18, and finally at high-pressure refrigerant outlet of heat exchanger 18, to measure the corresponding refrigerant temperatures.

In a further improved embodiment, central control unit 7 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature rise of the refrigerant flowing through the evaporator 13, i.e. flowing through heat exchanger 13, and of the temperature rise of the refrigerant flowing through the low-pressure side of internal heat exchanger 18.

As stated above, in case of refrigerant zeotropic blends, the temperature rise of the refrigerant flowing through the evaporator 13 is slightly higher than zero when the refrigerant coming out of evaporator 13 is partly in liquid state.

Instead, when the refrigerant coming out of evaporator 13 is completely in gaseous state, the temperature rise of the refrigerant flowing through the low-pressure side of internal heat exchanger 18 is significantly high, i.e. significantly greater than zero, because the refrigerant flowing in the low-pressure side of internal heat exchanger 18 is to be only superheated.

In view of the above, central control unit 7 of laundry dryer 1 can measure both the temperature rise of the refrigerant flowing in the evaporator 13, and the temperature rise of the refrigerant flowing in the low-pressure side of internal heat exchanger 18; and, when hot-air generator is in the steady-state working phase, it can switch the cooling fan 20 on and off (i.e. adjust the “thermodynamic quality ratio” TQ of the refrigerant at refrigerant-outlet of evaporator 13), so as to keep the temperature rise of the refrigerant flowing through the evaporator 13 as constant as possible within a first narrow temperature range located above 0° C., and which preferably, though not necessarily, extends from 2° C. and 8° C., and, at the same time, so as to keep the temperature rise of the refrigerant flowing through the low-pressure side of heat exchanger 18 within a second broader temperature range which is always above than the first temperature range, and which preferably, though not necessarily, extends from 3° C. to 20° C.

Thus, central control unit 7 is preferably, though not necessarily, configured/programmed
to reduce the “thermodynamic quality ratio” TQ of the refrigerant at refrigerant-outlet of heat exchanger 13, when the temperature rise of the refrigerant flowing through the evaporator 13 exceeds the upper limit of said first temperature range (for example 8° C.), and when the temperature rise of the refrigerant flowing through the low-pressure side of heat exchanger 18 exceeds the upper limit of said second temperature range (for example 25° C.); and
to increase the “thermodynamic quality ratio” TQ of the refrigerant at refrigerant-outlet of heat exchanger 13, when the temperature rise of the refrigerant flowing through the evaporator 13 goes below the lower limit of the first temperature range (for example 2° C.), and when, at the same time, the temperature rise of the refrigerant flowing through the low-pressure side of heat exchanger 18 goes below the lower limit of said second threshold value (for example 3° C.).

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the temperature rise of the refrigerant flowing through the evaporator 13 exceeds a first threshold value (for example 4° C.), and whenever the temperature rise of the refrigerant flowing through the low-pressure side of internal heat exchanger 18 exceeds a second threshold value (for example 25° C.); and deactivates the cooling fan 20 for increasing the “thermodynamic quality ratio” TQ of the refrigerant at refrigerant-outlet of heat exchanger 13, whenever the temperature rise of the refrigerant flowing through the evaporator 13 goes below a third threshold value (for example 2° C.) which is lower than said first threshold value, and the temperature rise of the refrigerant flowing through the low-pressure side of internal heat exchanger 18 goes below a fourth threshold value (for example 3° C.) which is lower than said second threshold value. Activation of cooling fan 20, in fact, reduces the “thermodynamic quality ratio” TQ of the refrigerant at refrigerant-outlet of heat exchanger 13; whereas deactivation of cooling fan 20 increases the “thermodynamic quality ratio” TQ of the refrigerant at refrigerant-outlet of heat exchanger 13.

The fourth threshold value is always greater than the second threshold value.

In the first case, a complete evaporation of the refrigerant is taking place inside the evaporator 13, i.e. inside the air/refrigerant heat exchanger 13, and the heat exchanger 18 finalizes only the superheating of the refrigerant. In the second case, the liquid state portion of the refrigerant coming out from the evaporator 13 is excessive, and the internal heat exchanger 18 is not able to finalize the evaporation of low-pressure refrigerant and afterwards superheat the refrigerant directed towards the suction of refrigerant compressing device 15.

To perform this improved control-strategy, the laundry dryer 1 is again provided with three temperature sensors located, respectively, at refrigerant-inlet of the evaporator 13, at refrigerant-outlet of the evaporator 13, and finally at low-pressure refrigerant outlet of heat exchanger 18, to measure the corresponding refrigerant temperatures. The refrigerant temperature at low-pressure refrigerant inlet of heat exchanger 18, in fact, is to be considered equal to the refrigerant temperature at refrigerant-outlet of heat exchanger 13.

In a seventh embodiment, central control unit 7 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature drop of the refrigerant flowing in the high-pressure side of internal heat exchanger 18.

In fact, as previously explained, the drop of the refrigerant temperature at the high-pressure side of internal heat exchanger 18 is very high when the refrigerant coming out of evaporator 13 is partly in liquid state, because the high-temperature and high-pressure refrigerant flowing through internal heat exchanger 18 has to transfer to the low-pressure refrigerant flowing through the same heat exchanger enough heat to finalize both the evaporation and the superheating of the refrigerant.

In other words, taking into consideration that the average thermal capacity of the bi-phase refrigerant is considerably higher than the thermal capacity of the same refrigerant in gaseous state, the drop of the refrigerant temperature at the high-pressure side of internal heat exchanger 18 is much higher when the evaporator 13 does not finalize the evaporation of the refrigerant within itself (i.e. when the temperature of the refrigerant at refrigerant-outlet of evaporator 13 is lower than the corresponding refrigerant saturation temperature), than when the evaporator 13 finalizes evaporation of the refrigerant within itself.

In view of the above, central control unit 7 of laundry dryer 1 can measure the temperature drop of the refrigerant flowing in the high-pressure side of internal heat exchanger 18 and, when the hot-air generator is in the steady-state working phase, it can switch the cooling fan 20 on and off (i.e. drive the refrigerant cooling device 17,), so as to keep the temperature drop of the refrigerant flowing in the high-pressure side of internal heat exchanger 18 within a predetermined temperature range whose upper and lower ends are both higher than 0° C. This temperature range assures that the complete vaporization and superheating of the refrigerant takes place inside internal heat exchanger 18, and that the “thermodynamic quality ratio” TQ of the refrigerant coming out of the evaporator 13 remains encompassed between 0.7 and 1.2.

In particular, the upper and lower ends of this temperature range are preferably conveniently selected so that the “thermodynamic quality ratio” TQ of the refrigerant coming out of evaporator 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, this temperature range extends preferably, though not necessarily, from 3° C. to 20° C.

In view of the above, central control unit 7 of laundry dryer 1 is preferably, though not necessarily, configured/programmed
to reduce the “thermodynamic quality ratio” TQ of the refrigerant at refrigerant-outlet of heat exchanger 13 when the temperature drop of the refrigerant flowing in the high-pressure side of internal heat exchanger 18 goes below the lower limit of said first temperature range (for example 3° C.); and
to increase the “thermodynamic quality ratio” TQ of the refrigerant at refrigerant-outlet of heat exchanger 13 when the temperature drop of the refrigerant flowing in the high-pressure side of internal heat exchanger 18 exceeds the upper limit of said first temperature range (for example 20° C.).

In other words, when hot-air generator 5 is in the steady-state working phase, central control unit 7 of laundry dryer 1 activates the cooling fan 20 for reducing the current “thermodynamic quality ratio” TQ of the refrigerant at refrigerant-outlet of the evaporator 13, whenever the temperature drop of the refrigerant flowing in the high-pressure side of internal heat exchanger 18 goes below a first threshold value (for example 3° C.); and deactivates the cooling fan 20 for increasing the current “thermodynamic quality ratio” TQ of the refrigerant at refrigerant-outlet of the evaporator 13, whenever the temperature drop of the refrigerant flowing in the high-pressure side of internal heat exchanger 18 exceeds a second threshold value (for example 20° C.) which is higher than said first threshold value.

To perform this seventh control-strategy, the laundry dryer 1 is provided with two temperature sensors located, respectively, at high-pressure refrigerant inlet and at high-pressure refrigerant outlet of internal heat exchanger 18 to measure the corresponding refrigerant temperatures.

In an eighth embodiment, central control unit 7 maintains, when hot-air generator 5 is in the steady-state working phase, the “thermodynamic quality ratio” TQ of the refrigerant at refrigerant-outlet of evaporator 13 between 0.7 and 1.2, via a selected activation and deactivation of cooling fan 20 on the basis of the temperature rise of the refrigerant flowing in the low-pressure side of internal heat exchanger 18.

In fact, the increase of the refrigerant temperature flowing in the low-pressure side of the internal heat exchanger 18 is much higher when the evaporator 13 finalizes the refrigerant evaporation, than when the evaporator 13 does not finalize the refrigerant evaporation and the low-pressure refrigerant comes out of evaporator 13 partly in liquid state (i.e. with a current temperature lower than the corresponding refrigerant saturation temperature). This is due to the fact that the average thermal capacity of the bi-phase refrigerant is considerably higher than the thermal capacity of the same gaseous-state refrigerant.

In other words, when the evaporator 13 finalizes evaporation of the refrigerant and the low-pressure refrigerant coming out of evaporator 13 is completely in gaseous state, the refrigerant flowing in the low-pressure side of internal heat exchanger 18 is merely subjected to superheating. Instead, when the evaporator 13 does not finalize the evaporation of the refrigerant and the low-pressure refrigerant coming out of evaporator 13 is partly in liquid state, the refrigerant flowing in the low-pressure side of internal heat exchanger 18 is firstly subjected to a complete evaporation and afterwards is subjected to superheating.

Being the thermal capacity of the bi-phase refrigerant considerably higher than the thermal capacity of the gaseous-state refrigerant, this implies that an equal amount of heat arriving from the high-pressure side of internal heat exchanger 18 produces, in the refrigerant flowing in the low-pressure side of heat exchanger 18, an increase of the refrigerant temperature which is significantly higher when the evaporator 13 finalizes evaporation of the refrigerant, than when the evaporator 13 does not finalize the evaporation of the refrigerant.

Thus, central control unit 7 of laundry dryer 1 can measure the temperature rise of the refrigerant flowing in the low-pressure side of internal heat exchanger 18, and, when the hot-air generator is in the steady-state working phase, it can continuously switch on and off the cooling fan 20 so as to keep the temperature rise of the refrigerant flowing in the low-pressure side of internal heat exchanger 18 within a given temperature range whose ends are both higher than 0° C. The upper and lower ends of this temperature range are properly selected to assure that the vaporization of the refrigerant is finalized in internal heat exchanger 18, and that the “thermodynamic quality ratio” TQ of the refrigerant coming out of heat exchanger 13 remains encompassed between 0.7 and 1.2.

In particular, the upper and lower ends of this temperature range are preferably conveniently selected so that the “thermodynamic quality ratio” TQ of the refrigerant coming out of evaporator 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range extends preferably, though not necessarily, from 3° C. to 20° C.

In view of the above, central control unit 7 may be preferably, though not necessarily, configured/programmed
to reduce the “thermodynamic quality ratio” TQ of the refrigerant at refrigerant-outlet of the evaporator 13 when the temperature rise of the refrigerant flowing in the low-pressure side of internal heat exchanger 18 exceeds the upper limit (for example 20° C.) of said temperature range; and
to increase the “thermodynamic quality ratio” TQ of the refrigerant at refrigerant-outlet of the evaporator 13 when the temperature rise of the refrigerant flowing in the low-pressure side of internal heat exchanger 18 goes below the lower limit (for example 3° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the temperature rise of the refrigerant flowing in the low-pressure side of internal heat exchanger 18 goes above a first threshold value (for example 20° C.); and deactivates the cooling fan 20 for increasing the “thermodynamic quality ratio” TQ of the refrigerant at refrigerant-outlet of heat exchanger 13, whenever the temperature rise of the refrigerant flowing in the low-pressure side of internal heat exchanger 18 goes below a second threshold value (for example 3° C.) which is lower than said first threshold value.

Activation of cooling fan 20, in fact, reduces the “thermodynamic quality ratio” TQ of the refrigerant at refrigerant-outlet of evaporator 13, whereas deactivation of cooling fan 20 increases the “thermodynamic quality ratio” TQ of the refrigerant at refrigerant-outlet of evaporator 13.

Obviously, the first and the second threshold value are conveniently selected so to assure that the average “thermodynamic quality ratio” TQ of the refrigerant coming out of the evaporator 13 remains encompassed between 0.7 and 1.2, or preferably between 0.7 and 1.15, or preferably between 0.7 and 1.07, or even preferably between 0.7 and 1.03. Alternatively, the first and the second threshold value could be conveniently selected so as to maintain the average “thermodynamic quality ratio” TQ encompassed between 1 and 1.15, or between 1 and 1.07, or even between 1 and 1.03.

To perform this eighth control-strategy, the laundry dryer 1 is provided with two temperature sensors located, respectively, at high-pressure refrigerant inlet and at high-pressure refrigerant outlet of internal heat exchanger 18 to measure the corresponding refrigerant temperatures.

In a simplified ninth embodiment central control unit 7 maintains, when hot-air generator 5 is in the steady-state working phase, the “thermodynamic quality ratio” TQ of the refrigerant coming out of the evaporator 13 remains encompassed between 0.7 and 1.2, via a selected activation and deactivation of cooling fan 20 on the basis of the refrigerant temperature measured at low-pressure refrigerant outlet of internal heat exchanger 18, or at suction of refrigerant compressing device 15. The refrigerant temperature, in fact, is roughly the same in both places.

In fact, a too low temperature of the refrigerant coming out of the low-pressure refrigerant outlet of internal heat exchanger 18 implies that the internal heat exchanger 18 is not able to sufficiently superheat the refrigerant arriving from the evaporator 13. This, in turn, implies that an excessive amount of the heat arriving from the high-pressure refrigerant is used for finalizing the evaporation of the low-pressure refrigerant, thus too much liquid-state refrigerant is coming out of evaporator 13.

On the contrary, a too high temperature of the refrigerant coming out of the low-pressure refrigerant outlet of internal heat exchanger 18 implies that an excessive superheating of the low-pressure refrigerant is taking place inside internal heat exchanger 18. This implies that a too low amount of the heat arriving from the high-pressure refrigerant is used for finalizing the evaporation of the low-pressure refrigerant, thus too few liquid-state refrigerant is coming out of heat exchanger 13.

In view of the above, central control unit 7 of laundry dryer 1 may be preferably, though not necessarily, configured/programmed to measure the refrigerant temperature at low-pressure refrigerant outlet of internal heat exchanger 18, and to continuously switch the cooling fan 20 on and off so as to keep the temperature of the refrigerant at suction of refrigerant compressing device 15, or at low-pressure refrigerant outlet of internal heat exchanger 18, within a given temperature range whose upper and lower ends are experimentally determined to assure that refrigerant vaporization is finalized inside internal heat exchanger 18, and that the “thermodynamic quality ratio” TQ of the refrigerant coming out of heat exchanger 13 remains encompassed between 0.7 and 1.2.

The upper and lower ends of this temperature range strictly depend on the structure of heat-pump assembly 11, namely of heat exchangers 13 and 18, and conveniently selected so that the “thermodynamic quality ratio” TQ of the refrigerant coming out of the evaporator 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range extends preferably, though not necessarily, between 20° C. and 40° C.

In view of the above, central control unit 7 of laundry dryer 1 is preferably, though not necessarily, configured/programmed
to reduce the “thermodynamic quality ratio” TQ of the refrigerant at refrigerant-outlet of evaporator 13 when the refrigerant temperature at suction of refrigerant compressing device 15 exceeds the upper limit (for example 35° C.) of said temperature range; and
to increase the “thermodynamic quality ratio” TQ of the refrigerant at refrigerant-outlet of evaporator 13 when the refrigerant temperature at suction of refrigerant compressing device 15 goes below the lower limit (for example 30° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the refrigerant temperature at suction of refrigerant compressing device 15 goes above a predetermined first threshold value (for example 35° C.); and deactivates the cooling fan 20, or minimizes the revolving speed of cooling fan 20, for increasing the “thermodynamic quality ratio” TQ of the refrigerant at refrigerant-outlet of heat exchanger 13, whenever the refrigerant temperature at suction of refrigerant compressing device 15 goes below a given predetermined second threshold value (for example 30° C.) which is lower that said first threshold value. Activation of cooling fan 20, in fact, reduces the “thermodynamic quality ratio” TQ of the refrigerant at refrigerant-outlet of evaporator 13; whereas deactivation of cooling fan 20 increases the “thermodynamic quality ratio” TQ of the refrigerant at refrigerant-outlet of evaporator 13.

As stated above, first and second threshold values are conveniently selected so that the “thermodynamic quality ratio” TQ of the refrigerant coming out of evaporator 13 remains encompassed between 0.7 and 1.2, or preferably between 0.7 and 1.15, or preferably between 0.7 and 1.07, or even preferably between 0.7 and 1.03.

Alternatively, first and second threshold values could be conveniently selected so as to maintain the average “thermodynamic quality ratio” TQ encompassed between 1 and 1.15, or between 1 and 1.07, or even between 1 and 1.03.

In other words, if hot-air generator 5 is in the steady-state working phase, central control unit 7 of laundry dryer 1 is configured/programmed to keep the cooling fan 20 switched on when the refrigerant temperature at suction of refrigerant compressing device 15 gets too warm (for example it moves above 35° C.); and to keep the cooling fan 20 switched off when the refrigerant temperature at suction of refrigerant compressing device 15 gets too cold (for example it moves below 30° C.).

To perform this simplified ninth control-strategy, the laundry dryer 1 is provided with a temperature sensor (not shown) located at suction of refrigerant compressing device 15.

In a simplified tenth embodiment central control unit 7 maintains, when hot-air generator 5 is in the steady-state working phase, the “thermodynamic quality ratio” TQ of the refrigerant coming out of the evaporator 13 remains encompassed between 0.7 and 1.2, via a selected activation and deactivation of cooling fan 20 on the basis of the refrigerant temperature measured at refrigerant-inlet of condenser 14, i.e. of the air/refrigerant heat exchanger 14, or at delivery of refrigerant compressing device 15. The refrigerant temperature, in fact, is the same in both places.

This tenth control-strategy is based on the fact that the temperature rise of the refrigerant flowing in the refrigerant compressing device 15 is strictly correlated to the thermodynamic compression to which the refrigerant is subjected inside refrigerant compressing device 15. This thermodynamic compression, in turn, depends on some mechanical features of the refrigerant compressing device 15, namely the compression ratio, thus the refrigerant temperature measured at refrigerant-inlet of condenser 14, or at delivery of refrigerant compressing device 15, depends on the temperature of the refrigerant at suction of the refrigerant compressing device 15.

Being the temperature of the refrigerant at suction of the refrigerant compressing device 15 roughly equal to the temperature of the refrigerant coming out of the low-pressure refrigerant outlet of internal heat exchanger 18, all considerations concerning the temperature of the refrigerant coming out of the low-pressure refrigerant outlet of internal heat exchanger 18 can be repeated with reference to the refrigerant temperature measured at refrigerant-inlet of the condenser 14, or at delivery of the refrigerant compressing device 15.

In other words, a too low temperature of the refrigerant coming out of the refrigerant compressing device 15 implies that internal heat exchanger 18 is not able to sufficiently superheat the refrigerant arriving from the evaporator 13, and that therefore too much liquid-state refrigerant is coming out of the evaporator 13; whereas a too high temperature of the refrigerant coming out of the refrigerant compressing device 15 implies that an excessive superheating of the low-pressure refrigerant is taking place inside internal heat exchanger 18, and that therefore too few or none liquid-state refrigerant is coming out of the evaporator 13.

In view of the above, central control unit 7 of laundry dryer 1 is preferably, though not necessarily, configured/programmed to measure the temperature of the refrigerant at refrigerant-inlet of condenser 14, and to continuously switch on and off the cooling fan 20 so as to keep the temperature of the refrigerant at refrigerant-inlet of condenser 14, or at delivery of refrigerant compressing device 15, within a given temperature range whose upper and lower ends are experimentally determined to assure that refrigerant vaporization is finalized inside internal heat exchanger 18, and that the “thermodynamic quality ratio” TQ of the refrigerant coming out of the evaporator 13 remains encompassed between 0.7 and 1.2.

Obviously, the upper and lower ends of this temperature range strictly depend on the structure of heat-pump assembly 11, namely of the heat exchangers 13 and 18 and of the refrigerant compressing device 15, and are conveniently selected so that the “thermodynamic quality ratio” TQ of the refrigerant coming out of heat exchanger 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range extends preferably, though not necessarily, between 60° C. and 120° C.

In view of the above, central control unit 7 of laundry dryer 1 is configured/programmed
to reduce the “thermodynamic quality ratio” TQ of the refrigerant at refrigerant-outlet of heat exchanger 13 when the refrigerant temperature at delivery of refrigerant compressing device 15, or at refrigerant-inlet of condenser 14, exceeds the upper limit (for example 95° C.) of said temperature range; and
to increase the “thermodynamic quality ratio” TQ of the refrigerant at refrigerant-outlet of heat exchanger 13 when the refrigerant temperature at delivery of refrigerant compressing device 15, or at refrigerant-inlet of condenser 14, goes below the lower limit (for example 90° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the refrigerant temperature at delivery of refrigerant compressing device 15 moves above a predetermined first threshold value (for example 95° C.); and deactivates the cooling fan 20, or minimizes the revolving speed of cooling fan 20, for increasing the “thermodynamic quality ratio” TQ of the refrigerant at refrigerant-outlet of heat exchanger 13, whenever the refrigerant temperature at delivery of refrigerant compressing device 15 moves below a given predetermined second threshold value (for example 90° C.) which is lower that said first threshold value. Activation of cooling fan 20, in fact, reduces the “thermodynamic quality ratio” TQ of the refrigerant at refrigerant-outlet of heat exchanger 13, whereas deactivation of cooling fan 20 increases the “thermodynamic quality ratio” TQ of the refrigerant at refrigerant-outlet of heat exchanger 13.

Obviously, first and second threshold values are conveniently selected so that the “thermodynamic quality ratio” TQ of the refrigerant coming out of heat exchanger 13 remains encompassed between 0.7 and 1.2, or preferably between 0.7 and 1.15, or preferably between 0.7 and 1.07, or even preferably between 0.7 and 1.03. Alternatively, first and second threshold values could be conveniently selected so as to maintain the average “thermodynamic quality ratio” TQ encompassed between 1 and 1.15, or between 1 and 1.07, or even between 1 and 1.03.

In other words, if hot-air generator 5 is in the steady-state working phase, central control unit 7 of laundry dryer 1 is configured/programmed to keep the cooling fan 20 switch on when the refrigerant temperature at delivery of refrigerant compressing device 15, or at refrigerant-inlet of condenser 14, gets too warm (for example it moves above 95° C.); and to keep the cooling fan 20 switch off when the refrigerant temperature at delivery of refrigerant compressing device 15, or at refrigerant-inlet of condenser 14, gets too cold (for example it moves below 90° C.).

To perform this simplified tenth control-strategy, the laundry dryer 1 is provided with a temperature sensor (not shown) located at delivery of refrigerant compressing device 15 or at refrigerant-inlet of condenser 14.

In a simplified eleventh embodiment the central control unit 7 of laundry dryer 1 maintains, when hot-air generator 5 is in the steady-state working phase, the average “thermodynamic quality ratio” TQ of the refrigerant coming out of heat exchanger 13 remains encompassed between 0.7 and 1.2, via a selected activation and deactivation of cooling fan 20 on the basis of the refrigerant temperature measured at refrigerant outlet of auxiliary heat exchanger 19, or at high-pressure refrigerant inlet of heat exchanger 18.

For the same reasons referred in the previous embodiment, the temperature of the refrigerant coming out of refrigerant outlet of auxiliary heat exchanger 19 is strictly correlated to the temperature of the refrigerant coming out of the evaporator 13.

In fact, if the refrigerant is deeply superheated in heat exchanger 18, the refrigerant enters into the refrigerant compressing device 15 with a very high temperature. As a consequence the refrigerant temperature at delivery of the refrigerant compressing device 15 and at refrigerant-outlet of condenser 14 will be very high too. Consequently also the refrigerant temperature at refrigerant-outlet of auxiliary heat exchanger 19 will be very high.

Thus a too low temperature of the refrigerant coming out of the refrigerant outlet of auxiliary heat exchanger 19 implies that internal heat exchanger 18 is not able to sufficiently superheat the refrigerant arriving from the evaporator 13, and that too much liquid-state refrigerant is coming out of the evaporator 13; whereas a too high temperature of the refrigerant coming out of the refrigerant outlet of auxiliary heat exchanger 19 implies that an excessive superheating of the low-pressure refrigerant is taking place inside internal heat exchanger 18, and that too few or none liquid-state refrigerant is coming out of the evaporator 13.

In view of the above, central control unit 7 of laundry dryer 1 is preferably, though not necessarily, configured/programmed to measure the refrigerant temperature at refrigerant outlet of auxiliary heat exchanger 19, or at high-pressure refrigerant inlet of heat exchanger 18, and to continuously switch the cooling fan 20 on and off, so as to keep the temperature of the refrigerant at refrigerant outlet of auxiliary heat exchanger 19, or at high-pressure refrigerant inlet of heat exchanger 18, within a given temperature range whose upper and lower ends are experimentally determined to assure that refrigerant vaporization is finalized inside internal heat exchanger 18, and that the average “thermodynamic quality ratio” TQ of the refrigerant coming out of the evaporator 13 remains encompassed between 0.7 and 1.2.

Obviously, the upper and lower ends of this temperature range strictly depend on the structure of heat-pump assembly 11, are both considerably above 0° C., and are conveniently selected so that the “thermodynamic quality ratio” TQ of the refrigerant coming out of heat exchanger 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range extends preferably, though not necessarily, between 40° C. and 70° C.

Thus, central control unit 7 of laundry dryer 1 is configured/programmed
to reduce the “thermodynamic quality ratio” TQ of the refrigerant at refrigerant-outlet of heat exchanger 13 when the refrigerant temperature at refrigerant outlet of auxiliary heat exchanger 19, or at high-pressure refrigerant inlet of heat exchanger 18, exceeds the upper limit (for example 60° C.) of said temperature range; and
to increase the “thermodynamic quality ratio” TQ of the refrigerant at refrigerant-outlet of heat exchanger 13 when the refrigerant temperature at refrigerant outlet of auxiliary heat exchanger 19, or at high-pressure refrigerant inlet of heat exchanger 18, goes below the lower limit (for example 55° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the refrigerant temperature at refrigerant outlet of auxiliary heat exchanger 19, or at high-pressure refrigerant inlet of heat exchanger 18, moves above a predetermined first threshold value (for example 60° C.); and deactivates the cooling fan 20, or minimizes the revolving speed of cooling fan 20, for increasing the “thermodynamic quality ratio” TQ of the refrigerant at refrigerant-outlet of heat exchanger 13, whenever the refrigerant at refrigerant outlet of auxiliary heat exchanger 19, or at high-pressure refrigerant inlet of heat exchanger 18, moves below a given predetermined second threshold value (for example 55° C.) which is lower that said first threshold value. Activation of cooling fan 20, in fact, reduces the “thermodynamic quality ratio” TQ of the refrigerant at refrigerant-outlet of heat exchanger 13, whereas deactivation of cooling fan 20 increases the “thermodynamic quality ratio” TQ of the refrigerant at refrigerant-outlet of heat exchanger 13.

First and second threshold values are conveniently selected so that the “thermodynamic quality ratio” TQ of the refrigerant coming out of the evaporator 13 remains encompassed between 0.7 and 1.2, or preferably between 0.7 and 1.15, or preferably between 0.7 and 1.07, or even preferably between 0.7 and 1.03. Alternatively, first and second threshold values could be conveniently selected so as to maintain the average “thermodynamic quality ratio” TQ encompassed between 1 and 1.15, or between 1 and 1.07, or even between 1 and 1.03.

In other words, if hot-air generator 5 is in the steady-state working phase, central control unit 7 of laundry dryer 1 is configured/programmed to keep the cooling fan 20 switch on when the refrigerant temperature at refrigerant outlet of auxiliary heat exchanger 19, or at high-pressure refrigerant inlet of heat exchanger 18, gets too warm (for example it moves above 60° C.); and to keep the cooling fan 20 switch off when the refrigerant temperature at refrigerant outlet of auxiliary heat exchanger 19, or at high-pressure refrigerant inlet of heat exchanger 18, gets too cold (for example it moves below 55° C.).

To perform this simplified eleventh control-strategy, the laundry dryer 1 is provided with a temperature sensor (not shown) located at refrigerant outlet of auxiliary heat exchanger 19, or at high-pressure refrigerant inlet of heat exchanger 18.

In a simplified twelfth embodiment the central control unit 7 of laundry dryer 1 maintains, when hot-air generator 5 is in the steady-state working phase, the average “thermodynamic quality ratio” TQ of the refrigerant coming out of heat exchanger 13 remains encompassed between 0.7 and 1.2, via a selected activation and deactivation of cooling fan 20 on the basis of the refrigerant temperature measured at high-pressure refrigerant outlet of internal heat exchanger 18.

In fact, for the same reasons referred in the previous embodiments, the temperature of the refrigerant coming out of the high-pressure refrigerant outlet of internal heat exchanger 18 is strictly correlated to the temperature of the refrigerant coming out of the evaporator 13. Thus a too low temperature of the refrigerant coming out of the high-pressure refrigerant outlet of internal heat exchanger 18 implies that internal heat exchanger 18 is not able to sufficiently superheat the low-pressure refrigerant arriving from the evaporator 13, and that therefore a too much liquid-state refrigerant is coming out of the evaporator 13; whereas a too high temperature of the refrigerant coming out of the high-pressure refrigerant outlet of internal heat exchanger 18 implies that an excessive superheating of the low-pressure refrigerant is taking place inside internal heat exchanger 18, and that therefore a too few liquid-state refrigerant is coming out of the evaporator 13 or that the low-pressure refrigerant coming out of heat exchanger 13 is too much superheated.

In view of the above, central control unit 7 of laundry dryer 1 may be preferably, though not necessarily, configured/programmed to measure the refrigerant temperature at high-pressure refrigerant outlet of internal heat exchanger 18, and to continuously switch the cooling fan 20 on and off so as to keep the temperature of the refrigerant at high-pressure refrigerant outlet of internal heat exchanger 18 within a given temperature range, whose upper and lower ends are experimentally determined to assure that refrigerant vaporization is finalized inside internal heat exchanger 18, and that the “thermodynamic quality ratio” TQ of the refrigerant coming out of evaporator 13 remains encompassed between 0.7 and 1.2.

Obviously, the upper and lower ends of this temperature range strictly depend on the structure of heat-pump assembly 11, are both considerably above 0° C., and are conveniently selected so that the “thermodynamic quality ratio” TQ of the refrigerant coming out of heat exchanger 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range extends preferably, though not necessarily, between 25° C. and 65° C.

Thus, central control unit 7 of laundry dryer 1 is configured/programmed
to reduce the “thermodynamic quality ratio” TQ of the refrigerant at refrigerant-outlet of heat exchanger 13, when the refrigerant temperature at high-pressure refrigerant outlet of internal heat exchanger 18 exceeds the upper limit (for example 40° C.) of said temperature range; and
to increase the “thermodynamic quality ratio” TQ of the refrigerant at refrigerant-outlet of heat exchanger 13 when the refrigerant temperature at high-pressure refrigerant outlet of internal heat exchanger 18 goes below the lower limit (for example 35° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of evaporator 13, whenever the refrigerant temperature at high-pressure refrigerant outlet of internal heat exchanger 18 moves above a predetermined first threshold value (for example 40° C.); and deactivates the cooling fan 20, or minimizes the revolving speed of cooling fan 20, for increasing the “thermodynamic quality ratio” TQ of the refrigerant at refrigerant-outlet of evaporator 13, whenever the refrigerant temperature at high-pressure refrigerant outlet of internal heat exchanger 18 moves below a given predetermined second threshold value (for example 35° C.) which is lower that said first threshold value. Activation of cooling fan 20, in fact, reduces the “thermodynamic quality ratio” TQ of the refrigerant at refrigerant-outlet of the evaporator 13; whereas deactivation of cooling fan 20 increases the “thermodynamic quality ratio” TQ of the refrigerant at refrigerant-outlet of the evaporator 13.

First and second threshold values are conveniently selected so that the “thermodynamic quality ratio” TQ of the refrigerant coming out of heat exchanger 13 remains encompassed between 0.7 and 1.2, or preferably between 0.7 and 1.15, or preferably between 0.7 and 1.07, or even preferably between 0.7 and 1.03. Alternatively, first and second threshold values could be conveniently selected so as to maintain the average “thermodynamic quality ratio” TQ encompassed between 1 and 1.15, or between 1 and 1.07, or even between 1 and 1.03.

In other words, if hot-air generator 5 is in the steady-state working phase, central control unit 7 of laundry dryer 1 is configured/programmed to keep the cooling fan 20 switch on when the refrigerant temperature at high-pressure refrigerant outlet of internal heat exchanger 18 gets too warm (for example it moves above 40° C.); and to keep the cooling fan 20 switch off when the refrigerant temperature at high-pressure refrigerant outlet of internal heat exchanger 18 gets too cold (for example it moves below 35° C.).

To perform this simplified eleventh control-strategy, the laundry dryer 1 is provided with a temperature sensor (not shown) located at high-pressure refrigerant outlet of heat exchanger 18.

In a simplified thirteenth embodiment the central control unit 7 of laundry dryer 1 maintains, when hot-air generator 5 is in the steady-state working phase, the average “thermodynamic quality ratio” TQ of the refrigerant coming out of heat exchanger 13 remains encompassed between 0.7 and 1.2, via a selected activation and deactivation of cooling fan 20 on the basis of the current temperature of the airflow f coming out of condenser 14, i.e. of the air/refrigerant heat exchanger 14, directed back into revolving drum 3.

In fact, the temperature of the airflow f entering into revolving drum 3 is strictly correlated to the temperature of the high-pressure refrigerant entering into the condenser 14 of heat-pump assembly 11.

Thus, for the same reasons referred in the previous embodiments, an excessive reduction of the temperature of the airflow f entering into revolving drum 3 implies that internal heat exchanger 18 is not able to sufficiently superheat the low-pressure refrigerant arriving from the evaporator 13, and that, therefore, too much liquid-state refrigerant is coming out of the evaporator 13. Whereas an excessive increase of the temperature of the airflow f entering into revolving drum 3 implies that an excessive superheating of the low-pressure refrigerant is taking place inside internal heat exchanger 18, and that, therefore, too few liquid-state refrigerant is coming out of the evaporator 13.

In view of the above, central control unit 7 of laundry dryer 1 is preferably, though not necessarily, configured/programmed to switch on and off the cooling fan 20, so as to keep the temperature of the airflow f coming out of the air-outlet of the condenser 14, within a given temperature range whose upper and lower ends are experimentally determined to assure that refrigerant vaporization is finalized inside internal heat exchanger 18, and that the “thermodynamic quality ratio” TQ of the refrigerant coming out of the condenser 13 remains encompassed between 0.7 and 1.2.

Again, the upper and lower ends of this temperature range strictly depend on the structure of heat-pump assembly 11, are both considerably above 0° C., and are conveniently selected so that the “thermodynamic quality ratio” TQ of the refrigerant coming out of heat exchanger 13 remains encompassed preferably, though not necessarily, between 0.7 and 1.15, or between 0.7 and 1.07, or even between 0.7 and 1.03. Alternatively, the upper and lower ends of this temperature range could be conveniently selected so as to maintain the average “thermodynamic quality ratio” TQ encompassed between 1 and 1.15, or between 1 and 1.07, or even between 1 and 1.03.

In the example shown, in particular, the temperature range of the airflow f coming out of condenser 14 extends preferably, though not necessarily, between 50° C. and 80° C.

Thus, central control unit 7 of laundry dryer 1 is configured/programmed
to reduce the “thermodynamic quality ratio” TQ of the refrigerant at refrigerant-outlet of evaporator 13 when the air temperature of the airflow F coming out of condenser 14 exceeds the upper limit (for example 70° C.) of said temperature range; and
to increase the “thermodynamic quality ratio” TQ of the refrigerant at refrigerant-outlet of evaporator 13 when the air temperature of the airflow F coming out of condenser 14 goes below the lower limit (for example 65° C.) of said temperature range.

In other words, when hot-air generator 5 is in the steady-state working phase, central control unit 7 of laundry dryer 1 activates the cooling fan 20 for reducing the “thermodynamic quality ratio” TQ of the refrigerant at refrigerant-outlet of heat exchanger 13, whenever the air temperature of the airflow F coming out of condenser 14 moves above a predetermined first threshold value (for example 70° C.); and deactivates the cooling fan 20, or minimizes the revolving speed of cooling fan 20, for increasing the “thermodynamic quality ratio” TQ of the refrigerant at refrigerant-outlet of heat exchanger 13, whenever the air temperature of the airflow F coming out of condenser 14 moves below a given predetermined second threshold value (for example 65° C.) which is lower that said first threshold value.

Obviously, first and second threshold values are conveniently selected so that the “thermodynamic quality ratio” TQ of the refrigerant coming out of the evaporator 13 remains encompassed between 0.7 and 1.2, or preferably between 0.7 and 1.15, or preferably between 0.7 and 1.07, or even preferably between 0.7 and 1.03. Alternatively, first and second threshold values could be conveniently selected so as to maintain the average “thermodynamic quality ratio” TQ encompassed between 1 and 1.15, or between 1 and 1.07, or even between 1 and 1.03.

In other words, if hot-air generator 5 is in the steady-state working phase, central control unit 7 of laundry dryer 1 is configured/programmed to keep the cooling fan 20 switch on when the air temperature of the airflow F coming out of condenser 14 gets too warm (for example it moves above 70° C.); and to keep the cooling fan 20 switch off when the air temperature of the airflow F coming out of condenser 14 gets too cold (for example it moves below 65° C.).

To perform this thirteenth control-strategy, the laundry dryer 1 is provided with a temperature sensor (not shown) located at air-outlet of condenser 14, i.e. of air/refrigerant heat exchanger 14.

Obviously the central control unit 7 could use other physical quantities to determine whether the temperature of the refrigerant at refrigerant-outlet of evaporator 13 is above or below the corresponding refrigerant saturation temperature (condition for which the “thermodynamic quality ratio” TQ of the refrigerant is equal to 1), such as, for example, the current temperature of the refrigerant at refrigerant inlet of the evaporator 13, or the current temperature of the refrigerant at refrigerant outlet of the evaporator 13 or the current temperature of the refrigerant at refrigerant outlet of the condenser 14 or at refrigerant inlet of auxiliary heat exchanger 19.

It is anyway clear that, in all embodiments referred above, central control unit 7 controls the refrigerant thermodynamic-parameters adjusting means 17 (i.e. the refrigerant cooling device 17), to keep the temperature of the refrigerant at refrigerant-outlet of evaporator 13 in the close proximity of the corresponding refrigerant saturation temperature, so that the average “thermodynamic quality ratio” TQ of the refrigerant at refrigerant-outlet of evaporator 13 remains encompassed between 0.7 and 1.2, or preferably, though not necessarily, also between 0.7 and 1.15, or preferably, though not necessarily, also between 0.7 and 1.07, or preferably, though not necessarily, also between 0.7 and 1.03. Alternatively, the average “thermodynamic quality ratio” TQ could also be encompassed between 1 and 1.15, or between 1 and 1.07, or even between 1 and 1.03.

In turn, the refrigerant/refrigerant internal heat exchanger 18 is dimensioned so to finalize, in necessary, the evaporation of the low-pressure refrigerant and ensure that the refrigerant entering into the refrigerant compressing device 15 is in gaseous state, i.e. it is on the right side of the refrigerant vapor saturated curve F″, and has a temperature higher than the corresponding refrigerant saturation temperature, i.e. it is superheated.

The advantages connected to the particular structure of heat-pump assembly 11 are large in number.

First of all, maintaining the “thermodynamic quality ratio” TQ of the refrigerant at refrigerant-outlet of evaporator 13 around 1, allows to significantly increase the air cooling capacity of the evaporator 13, i.e. of the air/refrigerant heat exchanger 13, thus maximizing dehumidification process.

In fact, an approximately equal to 1 “thermodynamic quality ratio” TQ implies that the temperature of the refrigerant at refrigerant-outlet of evaporator 13 is approximately equal to the corresponding refrigerant saturation temperature.

This means that the low-pressure refrigerant remains partly in liquid state roughly up to the refrigerant-outlet of evaporator 13. Being the thermal capacity of a bi-phase state refrigerant significantly higher than that of a gaseous-state refrigerant, this condition allows to maximize the air cooling capacity of heat exchanger 13 and, consequently, to improve dehumidification process.

Moreover, even if the refrigerant temperature at suction of refrigerant compressing device 15 is slightly higher than that of a traditional heat-pump assembly for laundry dryers due to the presence of the refrigerant/refrigerant heat exchanger 18—this implying that more power is required to the refrigerant compressing device 15 for compressing the refrigerant and complete the closed thermodynamic cycle—, in any case the air cooling capacity of the evaporator 13 increases much more than the power required by the refrigerant compressing device 15, thus significantly improving the overall energy efficiency of the heat-pump assembly 11. This favorable energy balance is particularly interesting with today's refrigerant such as R134a or R407C.

In addition to the above, air/refrigerant heat exchanger 19 and refrigerant/refrigerant heat exchanger 18 are “passive” components which have a very simplified configured, thus they are very cheap to produce and their incorporation into the heat-pump assembly does not significantly increase the overall production costs of the rotary-drum, heat-pump type, home laundry dryer.

Finally, air/refrigerant heat exchangers 13 and 14 can now be dimensioned so to have optimal performances when the hot-air generator 5 operates both in the steady state working conditions, and in the warm up working condition. Possibility barred to the traditional heat-pump type, closed-circuit, hot-air generators.

Clearly, changes may be made to the heat-pump assembly 11 of laundry dryer 1 and to the operating method as described herein without, however, departing from the scope of the present invention.

For example, instead of the refrigerant cooling device 17, the refrigerant thermodynamic-parameters adjusting means may comprise means configured to selectively vary the flow-rate of the refrigerant flowing through evaporator 13 and internal heat exchanger 18, i.e. along the heat-pump assembly 11.

These means for varying the flow-rate of the low-pressure refrigerant flowing through the evaporator 13 may comprise, for example:
a) an electrically-powered, variable-speed refrigerant compressing device which replaces the constant speed refrigerant compressing device 15, and which is configured to vary the flow-rate of refrigerant at the delivery of the compressing device;
b) an electrically-operated refrigerant expansion valve which replaces the passive expansion device 16, and which is configured to vary the flow-rate of refrigerant which is subjected to the substantially adiabatic, rapid expansion before entering into the heat exchanger 13; or
c) an electrically-operated multiple capillary-tube expansion system which replaces the passive expansion device 16, and which is configured to vary the flow-rate of the refrigerant which is subjected to the substantially adiabatic, rapid expansion while entering into heat exchanger 13.

When the refrigerant cooling device 17 is replaced by one of the referred-above means for varying the flow-rate of the refrigerant flowing through evaporator 13, the central control unit 7 of laundry dryer 1 controls said refrigerant flow-rate varying means so as to increase the flow-rate of the refrigerant flowing through the evaporator 13, i.e. through heat exchanger 13, in all working conditions in which activation of cooling fan 20 was previously requested; and so as to reduce the flow-rate of the refrigerant flowing into the evaporator 13 in all working conditions in which deactivation of cooling fan 20 was previously requested.

In fact, an increase of the flow-rate of the low-pressure refrigerant flowing through the evaporator 13 causes a rapid raising of the current pressure of the refrigerant flowing in the heat exchanger 13, i.e. inside the evaporator of heat-pump assembly 11. This raising of the current pressure of the refrigerant flowing in the refrigerant-inlet of the evaporator 13, in turns, causes an overall increase of the refrigerant pressure in the low-pressure side of heat-pump assembly 11.

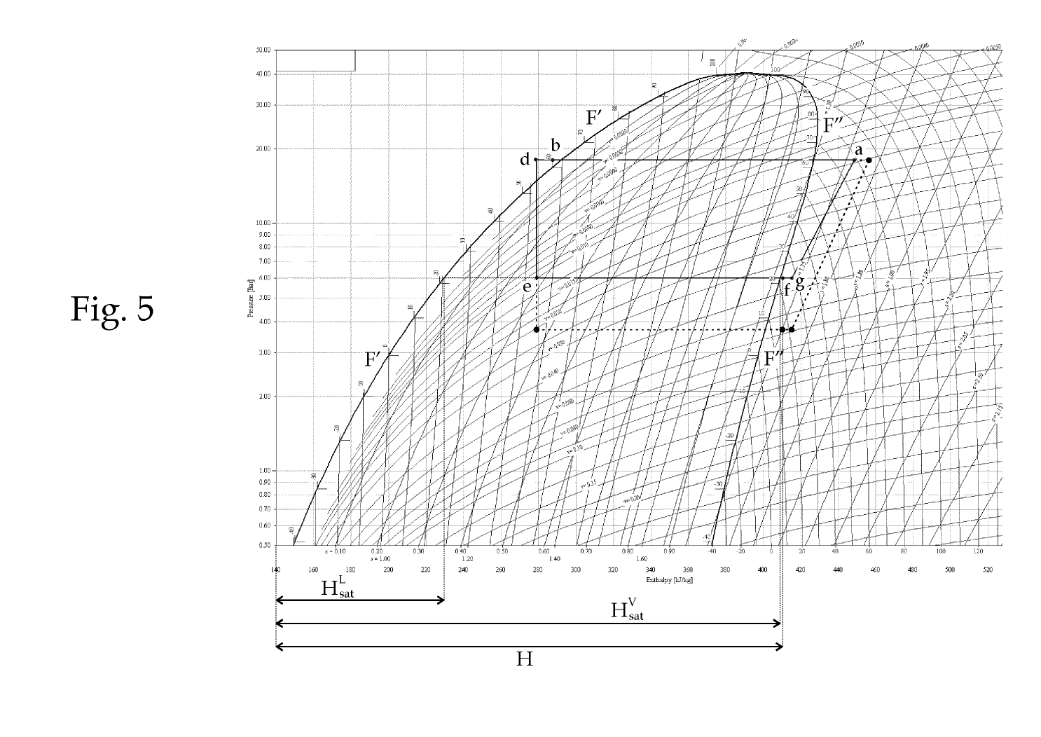

With reference to FIG. 5, assuming that the low-pressure refrigerant coming out of evaporator 13 was initially deeply superheated (i.e. Points f and g are both located on the right side of the refrigerant Saturated Vapor Curve F″ on the Pressure-Enthalpy chart), the overall increase of the refrigerant pressure in the low-pressure side of heat-pump assembly 11 implies that both Point e (corresponding to the refrigerant-inlet of evaporator 13) and Point f (corresponding to the refrigerant-outlet of evaporator 13 and to the low-pressure refrigerant-inlet of internal heat exchanger 18) on the Pressure-Enthalpy chart move upwards with respect to the previous positions on the Pressure-Enthalpy chart (the previous closed thermodynamic cycle is shown in dotted line in the FIG. 5 Pressure-Enthalpy chart).

Since Point f on the Pressure-Enthalpy chart (corresponding to the refrigerant-outlet of evaporator 13) was initially located on the right side of the refrigerant Saturated Vapor Curve F″, but not so faraway from the refrigerant Saturated Vapor Curve F″, the upwards displacement of both Points e and f on the Pressure-Enthalpy chart causes Point f to move closer to the refrigerant Saturated Vapor Curve F″, even up to reach or to climb over said refrigerant Saturated Vapor Curve F″.

In view of this rapid approach to the refrigerant Saturated Vapor Curve F″, the temperature of the low-pressure refrigerant at refrigerant-outlet of evaporator 13 becomes suddenly substantially equal to, or very close to, the corresponding refrigerant saturation temperature. This implies that the “thermodynamic quality ratio” TQ of the refrigerant at refrigerant-outlet of evaporator 13 moves suddenly from a value significantly greater than 1, to a new value which is lower than 1, or slightly greater than 1, depending on the final position of Point f with respect to the refrigerant Saturated Vapor Curve F″.

In the example shown (the new closed thermodynamic cycle is shown in solid line in the FIG. 5 Pressure-Enthalpy chart), for example, the new position of Point f is very close to the refrigerant Saturated Vapor Curve F″, but still on the right side of the latter. Thus the current temperature of the low-pressure refrigerant at refrigerant-outlet of evaporator 13 becomes suddenly only slightly greater than the corresponding refrigerant saturation temperature. Therefore the new value of the “thermodynamic quality ratio” TQ of the refrigerant at refrigerant-outlet of evaporator 13 becomes suddenly only slightly greater than 1.

Obviously, in case of a significant increase of the refrigerant pressure in the low-pressure side of heat-pump assembly 11, Point f would climb over the refrigerant Saturated Vapor Curve F″ and locates itself on the left side of the refrigerant Saturated Vapor Curve F″, relatively faraway from said refrigerant Saturated Vapor Curve F″.

In view of this overtaking of the refrigerant Saturated Vapor Curve F″, the current temperature of the low-pressure refrigerant coming out of evaporator 13 would become suddenly lower than the corresponding refrigerant saturation temperature, and as a consequence the “thermodynamic quality ratio” TQ of the refrigerant at refrigerant-outlet of evaporator 13 would change from a value significantly greater than 1, to a new value significantly lower than 1 (for example 0.6).

Clearly, a subsequent reduction of the flow rate of the low-pressure refrigerant flowing through evaporator 13 causes a rapid reduction of the refrigerant pressure in the low-pressure side of heat-pump assembly 11, and the consequent returning of Point f of the Pressure-Enthalpy chart again on the right side of the refrigerant Saturated Vapor Curve F″, relatively faraway from said refrigerant Saturated Vapor Curve F″.

Via a direct control of the refrigerant flow-rate, central control unit 7 can, therefore, move up and down the refrigerant pressure in the low-pressure side of heat-pump assembly 11 so as to maintain the average “thermodynamic quality ratio” TQ of the refrigerant at refrigerant-outlet of evaporator 13 within a given operative range encompassed between 0.7 and 1.2, or preferably between 0.7 and 1.15, or preferably between 0.7 and 1.07, or preferably even between 0.7 and 1.03. Alternatively, the operative range of the “thermodynamic quality ratio” TQ could be encompassed between 1 and 1.15, or between 1 and 1.07, or even between 1 and 1.03. Last but not least, the central control unit 7 of laundry dryer 1 may be configured/programmed to vary, during the drying cycle, the target value of the “thermodynamic quality ratio” TQ of the refrigerant at refrigerant-outlet of evaporator 13. In other words, during the drying cycle the central control unit 7 could, for example, initially maintain the target “thermodynamic quality ratio” TQ at 0.8, then rise the target “thermodynamic quality ratio” TQ at 0.90, and finally rise the target “thermodynamic quality ratio” TQ at 1, or even 1.05, so to maximize step-by-step the performance of the drying cycle.

1. Laundry dryer comprising an outer boxlike casing configured to rest on the floor and, inside the casing, a laundry container configured to house laundry to be dried, and a closed-circuit, hot-air generator configured to circulate through the laundry container a stream of hot air;
the hot-air generator comprising: an air recirculating conduit having its two ends connected to the laundry container; air circulator configured to produce, inside the air recirculating conduit, an airflow which flows through said laundry container; and a heat-pump assembly configured to cool the airflow coming out from the laundry container for condensing the moisture in said airflow, and then to heat the airflow returning back into the laundry container;
said heat-pump assembly comprising:
a first air/refrigerant heat exchanger which is located along the air recirculating conduit, and which is configured to transfer heat from the airflow arriving from the laundry container to the refrigerant so as to condense the moisture in the airflow;
a second air/refrigerant heat exchanger which is located along the air recirculating conduit, downstream of the first heat exchange, and which is configured to transfer heat from the refrigerant to the airflow directed back into the laundry container so as to heat said airflow;
a refrigerant compressing device which is interposed between the refrigerant-outlet of the first heat exchanger and the refrigerant-inlet of the second heat exchanger, and which is configured to compress the refrigerant directed towards the second heat exchanger so that refrigerant pressure and temperature are much higher at refrigerant-inlet of the second heat exchanger than at refrigerant-outlet of the first heat exchanger; and
a refrigerant expansion device which is interposed between the refrigerant-outlet of the second heat exchanger and the refrigerant-inlet of the first heat exchanger, and which is configured to produce an expansion of the refrigerant;
an auxiliary refrigerant/refrigerant heat exchanger comprising a high-pressure side and a low-pressure side, and which is configured so that the high- and low-pressure sides are thermically coupled one another so to allow heat transfer from the high-pressure and high-temperature refrigerant to the low-pressure and low-temperature refrigerant;
refrigerant cooler or refrigerant flow-rate adjuster which are configured to adjust, respectively, the temperature or the pressure of the low-pressure refrigerant at refrigerant-outlet of the first heat exchanger; and
detector able to measure the current value of at least one physical quantity associated to the heat-pump assembly and/or to the airflow; and
a central control unit configured to control said refrigerant cooler or refrigerant flow-rate adjuster according to the time-progression of said at least one physical quantity.

2. Laundry dryer according to claim 1, wherein the central control unit is configured to control said refrigerant cooler or refrigerant flow-rate adjuster so as to selectively maintain between 0.7 and 1.2 the value of the “thermodynamic quality ratio” of the refrigerant at refrigerant-outlet of said first heat exchanger; the “thermodynamic quality ratio” of the refrigerant being defined by the equation:
$$TQ = \frac{H - {H}_{sat}^{L}}{{H}_{sat}^{V} - {H}_{sat}^{L}}$$
wherein H is the current Enthalpy of the refrigerant at refrigerant-outlet of the first heat exchanger; Hₛₐₜ^{L} is the Enthalpy of the refrigerant when in Saturated Liquid Condition at current pressure of the refrigerant; and Hₛₐₜ^{V} is the Enthalpy of the refrigerant when in Saturated Vapor Condition at current pressure of the refrigerant.

3. Laundry dryer according to claim 2, wherein the central control unit is configured to control said refrigerant cooler or refrigerant flow-rate adjuster so as to maintain the “thermodynamic quality ratio” of the refrigerant at refrigerant-outlet of the first heat exchanger between 0.7 and 1.15.

4. Laundry dryer according to claim 3, wherein the central control unit is configured to control said refrigerant cooler or refrigerant flow-rate adjuster so as to maintain the “thermodynamic quality ratio” of the refrigerant at refrigerant-outlet of the first heat exchanger between 0.7 and 1.07.

5. Laundry dryer according to claim 4, wherein the central control unit is configured to control said refrigerant cooler or refrigerant flow-rate adjuster so as to maintain the “thermodynamic quality ratio” of the refrigerant at refrigerant-outlet of the first heat exchanger between 0.7 and 1.03.

6. Laundry dryer according to claim 1, wherein said at least one physical quantity is one of: the temperature or pressure of the refrigerant at refrigerant-inlet or at refrigerant-outlet of said first air/refrigerant heat exchanger; and the temperature rise or drop of the refrigerant flowing through said first air/refrigerant heat exchanger.

7. Laundry dryer according to claim 1, wherein said at least one physical quantity is one of: the temperature or pressure of the refrigerant at low-pressure refrigerant inlet or at low-pressure refrigerant outlet of the low-pressure side of said refrigerant/refrigerant heat exchanger; and the temperature or pressure of the refrigerant at high-pressure refrigerant inlet or at high-pressure refrigerant outlet of the high-pressure side of said refrigerant/refrigerant heat exchanger; and the temperature rise of the refrigerant flowing through the low-pressure side of said refrigerant/refrigerant heat exchanger; and the temperature drop of the refrigerant flowing through the high-pressure side of said refrigerant/refrigerant heat exchanger.

8. Laundry dryer according to claim 1, wherein said at least one physical quantity is the temperature or pressure of the refrigerant at suction or at delivery of said refrigerant compressing device.

9. Laundry dryer according to claim 1, wherein said at least one physical quantity is the temperature or pressure of the refrigerant at refrigerant inlet or at refrigerant outlet of said second air/refrigerant heat exchanger.

10. Laundry dryer according to claim 1, wherein said at least one physical quantity is the temperature or moisture degree of the airflow entering into, or coming out of, said laundry container.

11. Laundry dryer according to claim 1, wherein the refrigerant cooler comprises a third air/refrigerant heat exchange which is connected in series to the second air/refrigerant heat exchanger, and which is configured to selectively cool down the high-pressure refrigerant directed towards the refrigerant expansion device.

12. Laundry dryer according to claim 11, wherein said refrigerant cooler additionally comprises an auxiliary ventilation device which is configured to channel, on command, a stream of cooling air towards the body of said third air/refrigerant heat exchanger.

13. Laundry dryer according to claim 1, wherein said refrigerant flow-rate adjuster comprises one of: a variable speed refrigerant compressing device, and an electrically-operated refrigerant expansion valve, and an electrically-operated multiple capillary-tube expansion system.

14. Laundry dryer according to claim 7, wherein said detector comprises a sensor configured to detect the temperature or pressure of the refrigerant at one of: low-pressure refrigerant inlet of said refrigerant/refrigerant heat exchanger; and low-pressure refrigerant outlet of said refrigerant/refrigerant heat exchanger; and high-pressure refrigerant inlet of said refrigerant/refrigerant heat exchanger; and high-pressure refrigerant outlet of said refrigerant/refrigerant heat exchanger.

15. Operating method of a laundry dryer comprising an outer boxlike casing configured to rest on the floor and, inside the casing, a laundry container configured to house the laundry to be dried, and a closed-circuit, hot-air generator configured to circulate through the laundry container a stream of hot air; the hot-air generator being provided with a heat-pump assembly configured to cool the airflow coming out from the laundry container for condensing the moisture in said airflow, and then to heat the airflow returning back into the laundry container;
said heat-pump assembly comprising: a first air/refrigerant heat exchanger which is configured to transfer heat from the airflow arriving from the laundry container to a low-pressure refrigerant so as to condense the moisture in the airflow; and a second air/refrigerant heat exchanger which is configured to transfer heat from a high-pressure refrigerant to the airflow directed back into the laundry container so as to rapidly heat said airflow;
wherein the operating method comprises the steps of
measuring the current value of at least one physical quantity associated with at least one of: the heat-pump assembly and the airflow;
controlling, on the basis of the time-progression of said at least one physical quantity, refrigerant cooler or refrigerant flow-rate adjuster configured to adjust the temperature or pressure of the low-pressure refrigerant at refrigerant-outlet of the first heat exchanger;
feeding the refrigerant to a high-pressure side and to a low-pressure side of an auxiliary refrigerant/refrigerant heat exchanger for transferring heat from the high-pressure and high-temperature refrigerant flowing through the high-pressure side to the low-pressure and low-temperature refrigerant flowing through the low-pressure side.

16. Laundry-dryer operating method according to claim 15, wherein said refrigerant cooler or refrigerant flow-rate adjuster are controlled so as to selectively maintain between 0.7 and 1.2 the value of the “thermodynamic quality ratio” of the refrigerant at refrigerant-outlet of said first heat exchanger; the “thermodynamic quality ratio” of the refrigerant being defined by the equation:
$$TQ = \frac{H - {H}_{sat}^{L}}{{H}_{sat}^{V} - {H}_{sat}^{L}}$$
wherein H is the current Enthalpy of the refrigerant at refrigerant-outlet of the first heat exchanger; Hₛₐₜ^{L} is the Enthalpy of the refrigerant when in Saturated Liquid Condition at current pressure of the refrigerant; and Hₛₐₜ^{V} is the Enthalpy of the refrigerant when in Saturated Vapor Condition at current pressure of the refrigerant.

17. Laundry-dryer operating method according to claim 16, wherein said refrigerant cooler or refrigerant flow-rate adjuster are controlled so as to selectively maintain between 0.7 and 1.15 the “thermodynamic quality ratio” of the refrigerant at refrigerant-outlet of the first heat exchanger.

18. Laundry-dryer operating method according to claim 17, wherein said refrigerant cooler or refrigerant flow-rate adjuster are controlled so as to selectively maintain between 0.7 and 1.07 the “thermodynamic quality ratio” of the refrigerant at refrigerant-outlet of the first heat exchanger.

19. Laundry-dryer operating method according to claim 18, wherein said refrigerant cooler or refrigerant flow-rate adjuster are controlled so as to selectively maintain between 0.7 and 1.03 the “thermodynamic quality ratio” of the refrigerant at refrigerant-outlet of the first heat exchanger.

20. Laundry-dryer operating method according to claim 15, wherein said at least one physical quantity is one of: the temperature or pressure of the refrigerant at refrigerant-inlet or at refrigerant-outlet of said first air/refrigerant heat exchanger; and the temperature rise or drop of the refrigerant flowing through said first air/refrigerant heat exchanger.

21-45. (canceled)
